(19) United States
(12) Patent Application Publication
(10) Pub. No.: US 2016/0358241 A1
(43) Pub. Date: Dec. 8, 2016

(54) SYSTEMS AND METHODS FOR FACILITATING THE CREATION, ORDERING, PROCESSING AND DELIVERY OF PERSONALIZED BEREAVEMENT PACKAGES

(71) Applicant: Matthew Trounce, Bristol (GB)

(72) Inventor: Matthew Trounce, Bristol (GB)

(21) Appl. No.: 14/967,065

(22) Filed: Dec. 11, 2015

Related U.S. Application Data
(63) Continuation of application No. 13/841,412, filed on Mar. 15, 2013, now abandoned.
Application No. 13/841,412 is a continuation-in-part of application No. 13/602,082, filed on Aug. 31, 2012, now abandoned.
(60) Provisional application No. 61/530,914, filed on Sep. 2, 2011.

(51) Int. Cl. G06Q 30/06

(52) U.S. Cl. CPC G06Q 30/0621; G06Q 30/0635

(57) ABSTRACT

The present invention provides methods, systems, apparatuses, and computer-readable media for allowing users to obtain personalized bereavement packages for a deceased individual. The present invention further provides, inter alia, a bereavement package ordering platform adapted to assist users with the selection, personalization and ordering of bereavement products and services and can generate bereavement package data based on the plurality of package selections received from the user. The bereavement package data includes product selection data indicating a plurality of print-based bereavement products selected or input by the user and product personalization data pertaining to a machine readable element for inclusion on one or more of the bereavement products. The bereavement package data can be provided to a printing vendor to produce the plurality of print-based bereavement products for delivery of the plurality of print-based bereavement products to an individual organizing a service.

### CROSS-REFERENCE TO RELATED APPLICATIONS

This application is a continuation of U.S. application Ser. No. 13/841,412 filed on Mar. 15, 2013, which is a continuation-in-part of U.S. application Ser. No. 13/602,082 filed on Aug. 31, 2012, which claims the benefit of U.S. Provisional Application 61/530,914 filed Sep. 2, 2011. The contents of all above-identified applications are incorporated herein in their entireties.

### FIELD OF INVENTION

The present invention generally relates to systems and methods, including computer programs, for providing an online service that facilitates the creation and ordering of personalized bereavement packages.

### BACKGROUND OF THE INVENTION

The death of an individual is typically a difficult and distressing time for the family members and friends of the deceased. Beyond the sadness and grief associated with the loss, family members and other individuals are also often required to face the challenging and demanding task of organizing the funeral. This is frequently an involved process and can include, among other things, choosing a funeral home, contacting a place of worship, arranging a wake or viewing, ordering flowers, contacting friends and family, and organizing the funeral service. Given the immediacy of the loss, organizing a funeral can be overwhelming to those responsible and often adds to the pain and distress of losing a loved one.

One of the areas of focus of the present invention pertains to a central part of organizing a funeral, namely, arranging the funeral or memorial service. Arranging the funeral service tends to be a time consuming and detail oriented process that requires the individuals who are planning the service to make numerous decisions. In addition to choosing the format for the service (e.g., burial, cremation, memorial, etc.), individuals are typically required to select, and provide input related to, the stationery for the service, such as order of service cards, attendance cards and thank-you cards, as well as other funeral service and memorial related items, such as condolence books, remembrance albums and memorial DVDs. One object of the present invention is to provide a service that streamlines this process and facilitates the creation and ordering of these items, thereby reducing the time and effort spent, and the stress felt, by the individuals organizing the funeral service.

Although funeral homes will often assist individuals with various aspects of organizing a funeral, this assistance is generally limited to providing recommendations of vendors and third-parties who are able to provide the required products and services. Typically, each of these vendors only provide a specific type or limited range of products and/or services. For example, an individual organizing a funeral may have to deal with at least one vendor to order funeral service stationery, a second vendor to order condolence books, a third vendor to order memorial albums and a fourth vendor to order memorial DVDs. As such, this approach often forces the individual to contact numerous, separate vendors in order to obtain all of the items needed for the funeral. In turn, the individual is required to deal with each vendor to ensure that the various items are produced and delivered correctly. Thus, the current approach has a number of disadvantages.

One such disadvantage is that the inefficiency associated with needing to deal with and manage numerous vendors increases the amount of time and effort an individual has to spend in connection with organizing a funeral. This added work can often lead to increased stress and discomfort. Also, because funerals are generally held within a few days after an individual passes, the required items must be selected, ordered, produced and delivered in a very short time-frame. As a result, another disadvantage is that there is an increased likelihood that one or more of the items will include an error or will not be delivered in time for the funeral. Yet another disadvantage is that ordering each of the required items from separate vendors leads to additional cost to the individual.

There is therefore a need for an arrangement, such as a software platform and corresponding systems and methods, that reduces the amount of time required to organize a funeral.

There is also a need for such an arrangement that allows an individual to obtain a wide-range of personalized funeral related products and services from a single vendor.

There is also a need for such an arrangement that provides an individual with personalized funeral related products and services accurately within a short period of time.

There is also a need for such an arrangement that reduces the cost to an individual associated with ordering personalized funeral related products and services.

There is also a need for such an arrangement that allows a funeral home to create and order personalized funeral related products and services for a customer.

There is also a need for such an arrangement that includes a web-based platform enabling funeral homes to manage the creation and ordering of personalized funeral related products and services.

There is also a need for such an arrangement that includes a web-based platform enabling a vendor to manage and process a large number of orders for personalized funeral related products and services.

There is also a need for such an arrangement that offers an enhanced, user-friendly experience.

The above and other needs are addressed by the systems and methods described herein.

### SUMMARY OF THE INVENTION

Methods, systems, apparatuses, and computer-readable media are provided for allowing users to obtain personalized bereavement packages. The personalized bereavement packages can be personalized by a user for the deceased individual. The present invention further provides, for example, a bereavement package ordering platform adapted to assist users with the creation, personalization and ordering of bereavement products and services that can generate bereavement package data based on the plurality of package selections received from the user. The bereavement package data includes product selection data indicating a plurality of print-based bereavement products selected by the user and product personalization data representing user content for inclusion in one or more of the print-based bereavement products. The bereavement package data can be provided to a printing vendor for production of the plurality of print-based bereavement products and delivery of the plurality of print-based bereavement products to an individual organizing a service.

In one embodiment, a system for allowing users to obtain personalized bereavement packages includes a computing device having physical memory storing instructions that cause the computing device to: provide a bereavement package ordering platform adapted to assist users with the creation, personalization and ordering of bereavement products and services; receive, from a user, a request to create a personalized bereavement package through the bereavement package ordering platform for an individual organizing a memorial service; receive, from the user, memorial service data associated with the memorial service; determine a plurality of bereavement products and services for presentation to the user based on the memorial service data; receive, from the user, a plurality of package selections pertaining to the plurality of presented bereavement products and services; generate bereavement package data based on the plurality of package selections received from the user, the bereavement package data including: product selection data indicating a plurality of print-based bereavement products selected by the user; and product personalization data representing user content for inclusion in one or more of the print-based bereavement products; and provide the bereavement package data to a printing vendor for production of the plurality of print-based bereavement products and delivery of the plurality of print-based bereavement products to the individual organizing the memorial service.

In another embodiment, the computing device is further adapted to: provide a bereavement package processing platform adapted to assist one or more users of the funeral home with managing and tracking a plurality of bereavement packages created, personalized, and ordered through the bereavement package ordering platform. The computing device can also be adapted to receive a selection from the user to package and deliver the plurality of print-based bereavement products in a bereavement box. In addition, the computing device can be adapted to receive a selection from the user of a bereavement package theme and wherein the plurality of bereavement products and services are determined at least in part on the selected theme.

In certain embodiments, the bereavement package ordering platform can be a web based service accessed by users through a network. The user can be an individual organizing a memorial service, or an employee of a funeral home and the individual organizing the memorial service can be a customer of the funeral home. The bereavement package data can include product design data representing a user defined layout for one or more of the print-based bereavement products, such as order of service cards, attendance cards, thank you cards, envelopes, a condolence book, a memorial photo album, and/or a keepsake box. Additionally, the bereavement products and services can include items such as a memorial DVD, a memorial website, a remote access/interactive service, and/or e-cards.

In certain other embodiments, providing the bereavement package data to the printing vendor includes: generating an electronic sample associated with one or more of the plurality of print-based bereavement products; providing the electronic sample to the user; receiving confirmation from the user; and providing, in response to receiving confirmation from the user, the bereavement package data to the printing vendor. Further, in some embodiments, the printing vendor maintains and hosts the bereavement package ordering platform.

In certain embodiments, the bereavement package ordering platform may be adapted to permit a user to create or provide a memorial presentation. The memorial presentation may be a video, slideshow, audio recording (e.g., song) or other type of presentation. A user may upload videos, audio recordings, images or other content to create a memorial presentation. A memorial presentation that is created or otherwise provided by a user may be made accessible on a website.

In certain embodiments, the bereavement package ordering platform may be adapted to permit a user to include a Quick Response code (QR code), or other type of barcode, to be provided with a product or service that is included in a bereavement package. The QR code can be included on physical or printed bereavement products, such as service cards, attendance cards, thank you cards, envelopes, condolence books, photo albums, and/or keepsake boxes. Additionally, the QR code can also be included along with electronic bereavement products and services such as e-cards, content of memorial CD or DVD, a memorial website, or other types of electronic content. In certain embodiments, when an individual scans a QR code that was included in a bereavement package using a mobile device, the mobile device launches a browser and accesses a uniform resource locator (URL) or web address that includes a memorial presentation.

Other benefits and features of the present invention may become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

Further features of the invention, its nature and various advantages will be more apparent from the following detailed description of the preferred embodiments, taken in conjunction with the accompanying drawings, in which like reference characters refer to like parts throughout, and in which:

FIG. 1 is a flow diagram of a process that may be used in connection with the creation (or modification) and customization of, and submission of an order for, a personalized bereavement package through a bereavement package ordering platform in accordance with certain embodiments;

FIG. 2 is a flow diagram of a process that may be used in connection with the management of user accounts and pending orders through the bereavement package ordering platform in accordance with certain embodiments;

FIG. 3 is a flow diagram of a process that may be used in connection with the management and creation of user accounts, customer accounts and custom web clients through a bereavement package processing platform in accordance with certain embodiments;

FIG. 4 is a flow diagram of a process that may be used in connection with the management, processing, fulfillment, and billing of orders for personalized bereavement packages through the bereavement package processing platform in accordance with certain embodiments;

FIG. 5 is a pictorial diagram illustrating a portion of the display of a web client having a user login page presented to users in connection with accessing the bereavement package ordering platform, according to certain embodiments;

FIG. 6 is a pictorial diagram illustrating a portion of the display of a web client having a order quantity selection page accessed by users through the bereavement package ordering platform, according to certain embodiments;

FIG. 7 is a pictorial diagram illustrating a portion of the display of a web client having a theme selection page accessed by users through the bereavement package ordering platform, according to certain embodiments;

FIG. 8 is a pictorial diagram illustrating a portion of the display of a web client having a theme selection page accessed by users through the bereavement package ordering platform, according to certain other embodiments;

FIG. 9 is a pictorial diagram illustrating a portion of the display of a web client having a deceased individual information page accessed by users through the bereavement package ordering platform, according to certain embodiments;

FIG. 10 is a pictorial diagram illustrating a portion of the display of a web client having a service information page accessed by users through the bereavement package ordering platform, according to certain embodiments;

FIG. 11 is a pictorial diagram illustrating a portion of the display of a web client having a bereavement product preview page that includes auto-generated content for an order of service product created through the bereavement package ordering platform, according to certain embodiments;

FIG. 12 is a pictorial diagram illustrating a portion of the display of a web client having a bereavement product preview page that includes auto-generated content for an attendance product created through the bereavement package ordering platform, according to certain embodiments;

FIG. 13 is a pictorial diagram illustrating a portion of the display of a web client having a photo upload page accessed by users through the bereavement package ordering platform, according to certain embodiments;

FIG. 14 is a pictorial diagram illustrating a portion of the display of a web client having a photo editing page for allowing users to edit photos uploaded through the bereavement package ordering platform, according to certain embodiments;

FIG. 15 is a pictorial diagram illustrating a portion of the display of a web client having a photo preview page for allowing users to preview photos edited through the bereavement package ordering platform, according to certain embodiments;

FIG. 16 is a pictorial diagram illustrating a portion of the display of a web client having a product customization page for allowing users to customize an order of service product created through the bereavement package ordering platform, according to certain embodiments;

FIG. 17 is a pictorial diagram illustrating a portion of the display of a web client having a content selection page for allowing users to select a hymn to be added to an order of service product created through the bereavement package ordering platform, according to certain embodiments;

FIG. 18 is a pictorial diagram illustrating a portion of the display of a web client having content selection page for allowing users to select a reading to be added to an order of service product created through the bereavement package ordering platform, according to certain embodiments;

FIG. 19 is a pictorial diagram illustrating a portion of the display of a web client having a product customization page that presents users with a list of the content associated with an order of service card created through the bereavement package ordering platform, according to certain embodiments;

FIG. 20 is a pictorial diagram illustrating a portion of the display of a web client having a product confirmation page that allows users to preview and confirm samples of one or more products and services created through the bereavement package ordering platform, according to certain embodiments;

FIG. 21 is a pictorial diagram illustrating a sample PDF file for an order of service product created through the bereavement package ordering platform, according to certain embodiments;

FIG. 22 is a pictorial diagram illustrating a sample PDF file for an attendance card created through the bereavement package ordering platform, according to certain embodiments;

FIGS. 23A and 23B are pictorial diagrams illustrating a portion of the display of a web client having an embedded viewer that allows the user to preview samples for one or more products or services created through the bereavement package ordering platform, according to certain embodiments; and

FIG. 24 is a pictorial diagram illustrating a portion of the display of a web client having an order confirmation page presented to users through the bereavement package ordering platform, according to certain embodiments.

### DETAILED DESCRIPTION OF THE INVENTION

Individuals responsible for organizing a funeral may face a challenging and daunting task relying on existing, limited and inefficient services provided by funeral homes if they want to order and receive all of the personalized funeral service and memorial related products and services required for the funeral. Where individuals wish to order such products and services from the funeral home or a single third-party vendor and/or where funeral homes wish to provide such products and services to individuals organizing a funeral, the systems, methods and arrangements described below allow the individuals and funeral homes to meet some or all of the above-identified needs.

Certain embodiments pertain to a development platform and corresponding arrangement which involve methods and systems that enable funeral home personnel to create and order personalized funeral related products for an individual organizing a funeral, without the need for technical knowledge and expertise.

The arrangements according to certain embodiments are characterized by a web-based software platform that addresses concerns facing individuals responsible for organizing a funeral such as timeliness, cost, efficiency, and accuracy. The software platform and corresponding systems and methods enable a funeral home to create and order a personalized bereavement package, containing a wide-range of funeral and memorial related products, for a customer from a single third-party vendor. In addition, the software platform and corresponding systems and methods enable a vendor to receive, manage and process orders for the personalized bereavement packages from funeral homes and to deliver the packages to individuals in a timely fashion. In certain of these embodiments, the web-based software platform may include a bereavement package ordering platform for providing the features and functionality associated with creating, customizing and/or ordering personalized bereavement packages, and a bereavement package processing platform for providing the features and functionality associated with managing, processing orders for personalized bereavement packages created through the bereavement package ordering platform. In certain other embodiments, the bereavement package ordering platform and bereavement package processing platform may be integrated into a single web-based software platform. In yet other embodiments, the bereavement package ordering platform and/or bereavement package processing platform may be implemented using any suitable form of computer hardware and/or software, such as stand-alone client applications, web applications, mobile applications, etc.

Using the software platform and corresponding systems and methods, any user can intuitively design, create and order personalized funeral and memorial products and services required in connection with the organization of a funeral. For example, a funeral home may meet with a customer who requires various products and services, such as stationery, condolence books, memorial albums and DVDs, a memorial website, etc. After discussing the funeral arrangements with the customer and gathering information regarding the desired products and services, a user (such as an employee at the funeral home) may access a web-based ordering service whereby the user can design, personalize, and order each of the products and services for the customer. Through the web-based ordering service, the user may create a new order for the customer, input the customer's information, select the desired products and services and specify the particular features, content and layout of each such product and service. Once the user has selected and/or designed each of the desired products and services, the user may then submit the order for the products and services. Custom or personalized user content, user defined content, or user defined layout includes any data that is customized or personalized by the user for any of the products and services. When an order is submitted, it may be received by a vendor (such as a central printing service). Through the software platform, the vendor may manage and track each of the orders submitted through the web-based ordering service. When an order is processed, the vendor may create and/or print each of products and services corresponding to the order. The products and services may then be delivered to the customer or user.

In certain embodiments, the products and services that may be provided through the web-based ordering service include, but are not limited to, order of service cards, attendance cards, thank you cards, envelopes, memorial or condolence books, memorial photo albums, memorial CDs or DVDs, bookmarks, memorial websites, keepsake boxes and various other types of stationery, poster boards, books, media, and other funeral service or memorial related items.

As used herein, the term “memorial service” includes any service held in honor of the dead, such as a funeral, a burial, a cremation, a wake, a religious service, a public or private ceremony or event, or any similar service.

In certain embodiments, the web-based ordering service may include the option to add one or more of the offered products and services to an order. For each such product or service, the web-based ordering service may allow the user to personalize the product or service by presenting the user with various templates, styles and/or designs from which to choose. One or more styles and templates may be targeted to certain customers based on the geographic location, occupation, hobbies, beliefs or interests of the deceased individual, such as military, sporting or religious themes. In certain other embodiments, the user may be given the option of using a default template or may be able to design a desired product or service from a blank form or template. The user may also select certain predefined features, options and content to include in each such product or service. According to certain of these embodiments, the user may further personalize the products and service by inputting or uploading custom content, such as text, images, videos and/or sound to the products and services.

According to certain embodiments, the user is able to review and proof one or more of the selected products and services to confirm their accuracy prior to submitting the order. The user may then choose to update one or more of the selected products and services and/or add to the order. In certain of these embodiments, the web-based ordering service may generate samples for each of the products and services that are presented to the user for review. For example, print-ready files (such as PDFs, multipage documents or similar file formats) may be generated, which allow the user to review the products and services in real-time while creating the order. As another example, one or more of the samples may be presented to the user through a viewer program associated with the web-based service. In certain other embodiments, the samples may be delivered to the user for review, such as via e-mail. In certain of these embodiments, the samples may be watermarked or overlaid with the word “Sample” or a similar designation in order to prevent unauthorized use of the samples.

In certain embodiments, the user may be required to pay for the selected products and services prior to submitting the order through the web-based platform. For example, the user may make a payment using a credit card, debit card, or any other suitable form of payment. In certain of these embodiments, the payment may be processed by the web-based service or a third party payment processor. In certain embodiments, a “token” based payment system may be implemented to facilitate quicker ordering, such as for repeat users. In certain other embodiments, users may be invoiced for payment after each order is submitted or after a specified period of time (e.g., monthly).

According to certain embodiments, the user may be able to manage and track one or more orders through the web-based service. In certain of these embodiments, such as where the user is a funeral home or similar organization, the user can access the service to view various information associated with that user's orders. For example, the user may be able to view the orders by status (e.g., incomplete, awaiting approval, awaiting processing, in progress, complete, etc.), time period, customer or any other suitable filters. The user may also be able to select a particular order to view more detailed information and/or to approve, modify or cancel the order, as applicable. In certain of these embodiments, a user may track and provide customers with information concerning the status of their orders through the web-based service.

According to certain preferred embodiments, the software platform and corresponding systems are provided, operated and maintained by a single vendor, such as a printing service, that is capable of processing, creating, manufacturing and packaging all of the products and services offered through the web-based service. In accordance with certain of these embodiments the system may include one or more central printing hubs that are used by the vendor to process the orders received through the platform. For example, each central printing hub may be responsible for processing orders associated with customers from a particular geographic region. In certain other embodiments, the platform may be operated by multiple vendors or by a single vendor that outsources the manufacture or creation of one or more products to various third-parties.

In certain embodiments, the software platform and corresponding systems allow a vendor and/or central printing hub to manage and process orders, create and manage customer accounts and/or manage payments and invoicing. In certain of the these embodiments, the vendor can view information concerning the orders received through the web-based service and filter the orders by certain criteria, such as status, order number, date/time, customer, etc. The vendor may also be able to modify or update certain information for each order. In certain embodiments, the vendor may be able to create and modify a customized web client for a particular customer, as discussed in more detail below.

In certain embodiments, after processing an order and creating the requested products and services, the vendor or central printing hub may deliver the products to the customer or user associated with the order. In accordance with certain preferred embodiments, the orders are processed within a short time-period (such as 24 hours) and the products are delivered directly to the customer using priority delivery services in order to minimize the delay in fulfilling the order.

According to certain preferred embodiments, the products selected by a user in connection with an order may be packaged within, and delivered to a user or customer in, one or more packages or boxes. In certain of these embodiments, the products are packaged in a single box, such as a keepsake, memorial or bereavement box. In certain of these embodiments, the user may be able to select the bereavement box as an optional feature through the web-based ordering service. According to certain of these embodiments, the box or package may be customized by the user. For example, the user may be able to select various features for the box, such as the size, color or layout of the box and images, text or designs to be printed on the box. In certain of these embodiments, the user may be able to select from among various predefined themes, templates, layouts or designs for the box. One or more styles and templates may be targeted to certain customers based on the geographic location, occupation, hobbies, beliefs or interests of the deceased individual, such as military, sporting or religious themes. According to certain of these embodiments, the user may also be able to input or upload custom content to be included on or in the box, such as a background image for the box lid or a photograph of the deceased individual. In certain of these embodiments, the size and layout of the box may be based on the type, amount, and quantity of each of the products selected by the user.

In certain embodiments, the web-based software platform may permit a user to identify, create or provide a memorial presentation. The memorial presentation may be a video, slideshow or audio recording (e.g., song). Other types of memorial presentations may also be identified, created or provided (e.g., a website dedicated to the deceased). A user creating a memorial presentation may input text and upload videos, audio recordings (e.g., songs), images and other content in order to create a memorial presentation. In addition, an user may also identify or provide a pre-existing memorial presentation (e.g., which was created without the assistance of the web-based software platform) by specifying a URL which indicates a web address for the memorial presentation or by uploading a copy of the memorial presentation to the web-based ordering service. A memorial presentation that is created, or otherwise provided by a user, may be made accessible to individuals through a network such as the Internet.

In certain embodiments, the web-based software platform may permit a user to include a Quick Response code (QR code), or other type of barcode, on or in conjunction with a product or service that is included in a bereavement package. The platform may create the QR code or the QR code may be provided by the user (e.g., the user provide a QR code that was created by a third party). The QR code can be included on physical or printed bereavement products, such as service cards, attendance cards, thank you cards, envelopes, condolence books, photo albums, keepsake boxes, or any other type of physical or printed bereavement product. The QR code can also be included with electronic bereavement products and services such as e-cards, content on memorial DVD or CD, a memorial website, or other types of electronic content.

A variety of different functions may be executed in response to scanning a QR code that was included with a bereavement product or service (regardless of whether the QR code is included on a printed or an electronic product or service). For example, in response to scanning or reading a QR code with a mobile device, the mobile device may launch a browser which is automatically directed to a URL or web address that is embedded in the QR code. The URL or web address may identify a memorial presentation or a web page that includes access to the memorial presentation (e.g., the memorial presentation may be a video embedded on the web page or the web page may provide a link that permits an individual to display or download the memorial presentation). The URL or web address may also identify other types of web pages or websites as well (e.g., websites that permit a user to order flowers and gifts or websites to make donations).

In certain embodiments, other types of functions may also be executed in response to an individual reading or scanning a QR code. For example, in response to scanning a QR code, a text message (e.g., SMS message) may be transmitted to a mobile device. The text message may include a copy of a memorial presentation or a hyperlink to the memorial presentation. Alternatively, the text message may include text, images, videos, or audio recordings related to the deceased or may provide detailed information about a memorial service (e.g., time, location and name of venue).

Other types of functions that may be executed in response to an individual reading or scanning a QR code may include functions which permit an individual to save and record a URL that identifies a presentation (e.g., saving the URL as a bookmark in a web browser application), or functions that automatically prompt a user to download a memorial presentation to a computing device (e.g., a cell phone, tablet, desktop computer or other type of computing device). In certain embodiments, an e-mail may be sent to an email address associated with an individual or computing device in response to reading or scanning a QR code. The e-mail may include a copy of a memorial presentation, a hyperlink to the memorial presentation, information about a memorial service, and/or information about the deceased. In even further embodiments, data may be saved to a device that reads or scans a QR code. For example, in the case that the scanning or reading device is a mobile phone, data may be added to a calendar application (e.g., which identifies the date or other information related to memorial services) or data associated with a memorial presentation (e.g., a picture, audio clip, small video or animation associated with a memorial presentation) may be stored on the reading device. The information that is stored on the device may be embedded in the QR code itself or may be retrieved from a URL that is embedded in the QR code. Other types of functions may also be executed in response to an individual scanning a QR code associated with a bereavement product or service.

As explained in further detail below, a user that accesses the web-based software platform to design, create or order personalized funeral and memorial products and services may be presented with options or selections that permit the user to include a QR code (or other type of barcode) on a printed or electronic memorial product or service. For example, when the user is ordering products and services using the web-based ordering platform, the user may be presented with an option (e.g., checkboxes or buttons) that permits the user to specify whether the user wants to include a QR code on one or more products or services that have been selected by the user.

If a user opts to include or associate a QR code with a selected product or service, the user may also be presented with a set of customization settings that permit the user to customize aspects relating to the QR code. Amongst other things, the customization settings may permit the user to specify the function that takes place in response to scanning or reading a QR code. For example, the user may indicate that a web browser is to be executed which automatically displays a memorial presentation in response to reading a QR code. The user may also specify that a text message e-mail is sent when the QR code is scanned.

In addition to specifying the function that takes place in response to scanning or reading a QR code, the customization settings may further allow the user to specify content associated with the selected function. For example, if the user chooses the function which involves launching a web browser to display a memorial presentation, the user may be identify a web address or URL that indicates the location of the memorial presentation or may be permitted to upload (or otherwise provide) a copy of the memorial presentation to the web-based software platform. The user may also be presented with an option for creating a memorial presentation using the web-based software platform. In the case that the user uploads or creates a memorial presentation, the web-based software platform may store the memorial presentation on a web server and make the memorial presentation accessible to individuals (or a subset of individuals having certain privileges) over the Internet. The web-based software platform may then create a QR code that includes an embedded web address or URL which identifies the location of the memorial presentation. When the web address or URL is read by a QR reader (e.g., a QR reader application on a mobile device), an associated device (e.g., which includes a QR reader application or which is in communication with a QR reader device) will automatically launch a web browser and display the memorial presentation in the web browser.

Likewise, if the user selects a function associated with transmitting a text message or e-mail in response to scanning or reading a QR code, the user may specify the content of the text message, including an text, images, slideshows, videos or hyperlinks which are included in the text message or e-mail.

While the disclosure herein provides examples relating to the use of QR codes in conjunction with bereavement products and services, it should be recognized that any type of machine-readable element or label which has the ability to record information may be included on or with the products and services disclosed herein. Hence, while the examples described in this disclosure primarily relate to providing QR codes in conjunction with a product or service that is provided by the web-based ordering system, other types of optical machine-readable element may be utilized in a similar fashion, including but not limited to any type of one-dimensional bar code (e.g., Universal Product Codes) or two-dimensional bar code. Thus, any details discussed herein regarding the user of QR codes should be understood to apply to all types of optical machine-readable elements, whether such optical machine-readable elements are currently in existence or developed at a later time.

It should also be recognized various types of reading devices may be utilized to read or scan a machine-readable label. The reading device may represent any device that is capable of reading a one-dimensional bar code, two-dimensional bar code or other type of machine readable element. For example, a reading device may represent mobile device, or other type of device, that includes an application that reads QR codes, bar codes or other types of machine-readable elements. Alternatively, a reading device may also represent an optical scanner device that is connected to a computing device such as a desktop computer.

As discussed in more detail below, according to certain preferred embodiments, the disclosed web-based software platform and corresponding systems and methods include one or more web clients and an administration client. In certain of these embodiments, the web clients may allow users, such as funeral home employees, to access certain features and functionality associated with the bereavement package ordering platform and the administration client may allow users, such as employees of a third-party vendor, to access certain features and functionality associated with the bereavement package processing platform. It should be noted, however, that the software platform and corresponding systems and methods may be implemented using any number of web clients and administration clients, an integrated web and administration client and/or other web-based clients, components and software programs that are responsible for providing some or all of the features and functionality described herein.

### Web Client

According to certain embodiments, the web client may provide various features and functionality, including those associated with viewing, selecting, personalizing and ordering various funeral and memorial related products and services offered by a vendor through the software platform, as discussed above. The web client may also provide users with limited administration related features, such as the ability to update and modify their account details and view previously created and submitted orders.

In certain embodiments, the web client is accessible only by funeral homes or similar organizations and their employees, representatives, etc. In accordance with certain of these embodiments, the funeral home may discuss funeral arrangements and desired products and services with a customer (e.g., an individual organizing a funeral) and then use the web client to create and submit an order on behalf of the customer. According to certain other embodiments, the web client may be utilized by any person who requires some or all of the products and services offered through the platform.

In certain embodiments, such as where the user is a funeral home or group of associated funeral homes, the platform may include multiple web clients each of which is associated with one or more users. Various features associated with the web clients may be customized by or based on the users, such as the backgrounds, colors and layout of the web client, the logos and branding included on the web client, the products and service offered to customers, and/or the options associated with each such product and service. In certain embodiments, users may be limited to, or may be provided the option of, using a generic or default web client.

According to certain embodiments, a user preferably accesses the web client through a website service showing various pages to create, update and submit an order for funeral and memorial related products and services. In certain embodiments, the user may have and/or be required to have a user account in order to login to the web client. After accessing and/or logging into the web client, the user may interact with a graphical user interface to create or update an order by selecting, and customizing one or more products and services. In certain of these embodiments, the user interface provides the user with the ability to select and combine predefined templates, layouts, and content elements associated with the products and service. This allows a user to create, design and personalize the products and services without any technical knowledge, such as expertise in graphic design. Templates provide an overall theme for one or more products and services, including, for example, templates for sports, sport teams, religions, geographic locations, flowers, peace motifs, etc. Layouts provide various layouts for the product or service, such as the size, shape and format of, and the location and format of, the content included in the product or service. Content elements provide the various content, such as text, images, video, and sounds that can be included within a product or service. In certain embodiments, one or more of content elements may be required for a particular product or service.

In certain embodiments, the user may be able to create and design custom templates, layouts and/or content elements. In accordance with certain of these embodiments, the user may input or upload content to be included in one or more of the products and services. For example, a user may upload an image, such as a background image or picture or a photograph of the deceased individual to be incorporated within one or more of the products or services. Similarly, a user may upload the individual's favorite song or a video of the individual or may input various text, such as a poem, hymn, quote, etc. Further examples of templates, layouts and content elements are discussed and listed below.

In certain embodiments, the interfaces provided by the web client that permit a user to select, customize and/or order one or more products and services may include a barcode option that permits a user to indicate whether a QR code should be included with one or more of the products and services selected by the user (or on packaging associated with a selected product or service). The barcode option may represent a checkbox, radio button, submit button, hyperlink, or other element that is displayed on an interface associated with the web client.

In certain embodiments, if a user decides to include a QR code on a selected product or service, the web client may display a customization interface to the client that permits the user to customize features of the QR code. In certain cases, the customization interface may be presented as an overlay element, pop-window or separate web page(s). The customization interface may permit a user to create a QR code and to select a functionality to be associated with a QR code (e.g., functions associated with displaying a memorial presentation in a browser, sending a text message, sending an e-mail, prompting user to download a memorial presentation, or other type of function). The customization interface may also permit a user to identify content that is to be associated with the selected functionality. For example, the user may identify a web address of a memorial presentation that is to be displayed in response to reading the QR code, or may specify the content (e.g., text, images, videos, slideshows, animations, etc.) of a text message or email that is sent is response to reading the QR code. The customization interface may allow a user to customize other features related to the QR code as well (e.g., the size of the QR code, the location of the QR on a product or packaging, the color of the QR code and other types of features).

According to certain embodiments, the web client may feature a graphical representation of the products and services and may show the user how a product or service will look based on the selection, inclusion or combination of various templates, layouts, and content elements. For example, as the user makes certain selections and/or creates and provides various templates, layouts and content, the display of the web client may be updated to reflect such selections and provide the user with a real-time sample of the selected product or service.

The web client may offer an enhanced, user-friendly platform in the form of a graphical wizard that steps users through the products and services offered via the web client and the available templates, layouts, and content elements and options associated with such products and services, and assists users in building their orders. According to certain embodiments, the web client may include a progress bar or similar feature, indicating the steps remaining to complete the application. Certain embodiments of the progress bar may include a customer information section, a deceased individual information section, a funeral service information section, a product and service selection section, a product design and customization section, and/or a order submittal section. In certain embodiments, the user may be permitted to disable the wizard and instead of being guided or stepped through the order creation process on a page-by-page basis, the steps may be combined into a single group of inputs, options and settings for the users to input and select as they desire.

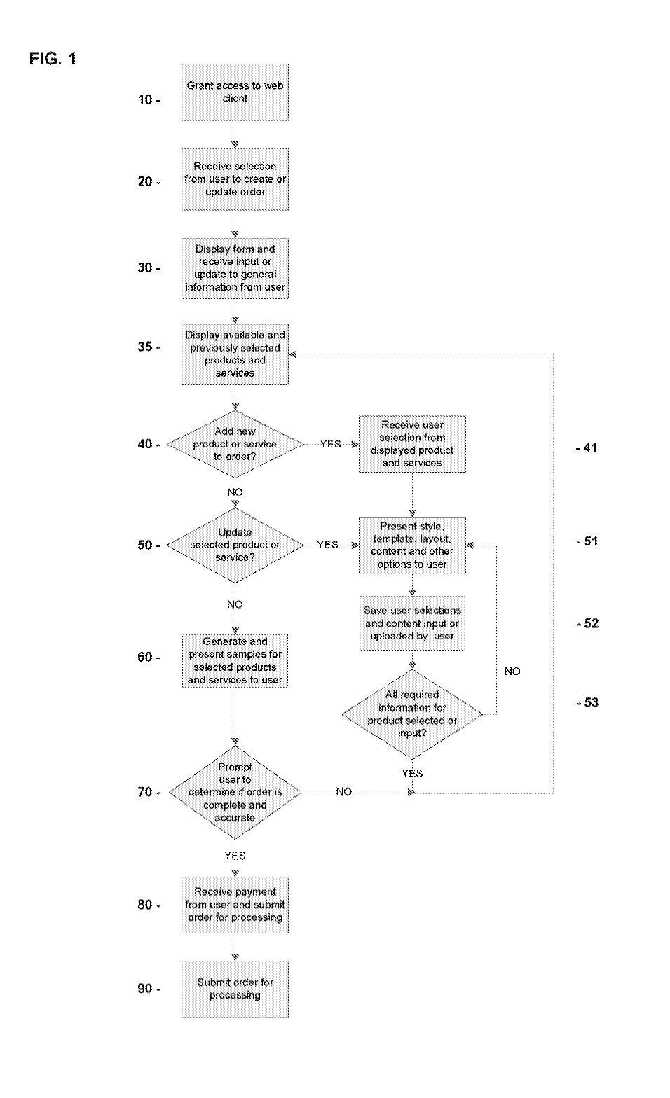

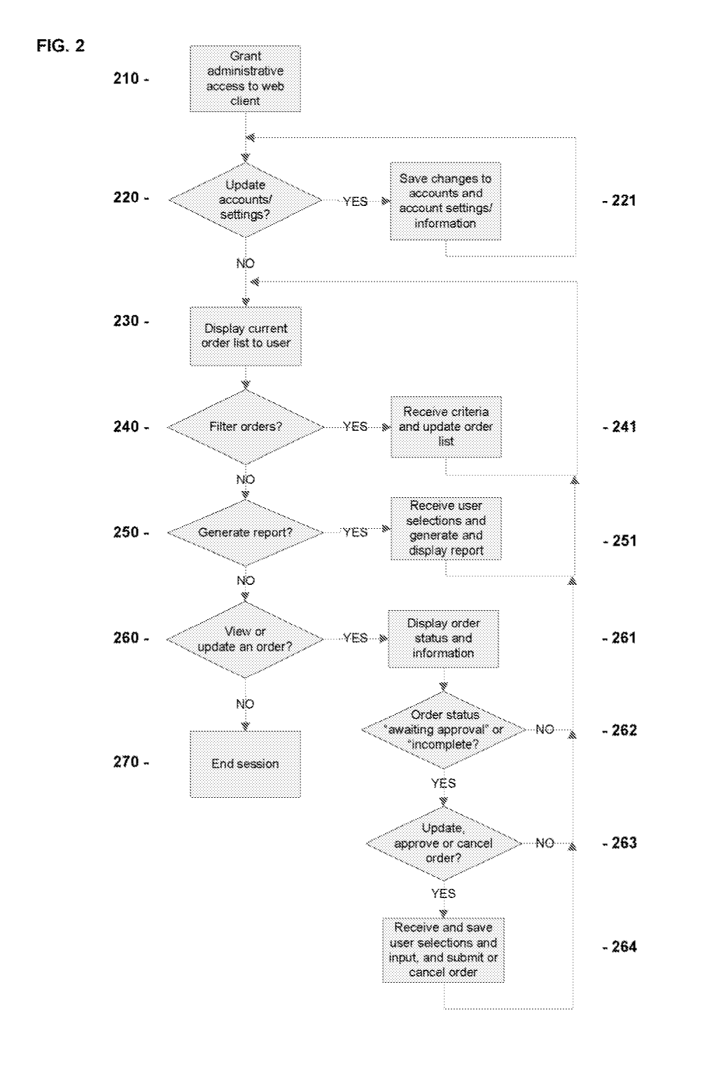

FIGS. 1 and 2 illustrate various exemplary steps involved in the creation (or modification), customization, and ordering of personalized bereavement packages, and the management of user accounts and pending orders in accordance with certain embodiments. FIGS. 1 and 2 are provided for purposes of illustration only, and it should be understood that one or more of the steps shown therein may be removed, replaced, repeated, performed in an alternate order and/or additional steps may be included.

FIG. 1 is a flow diagram of a process that may be used in connection with the creation (or modification) and customization of, and submission of an order for, a personalized bereavement package through a bereavement package ordering platform in accordance with certain embodiments. As shown in FIG. 1, a user may input login credentials to log into a website. Upon the submission of those login credentials to the website server, the user is granted access to the web client as shown in step 10. Once logged in the user may be presented with various options, such as the opportunity to create a new order or update an existing order that was started previously and saved by the user. In certain other embodiments, the user may also be presented with the opportunity to view and manage previously entered or submitted orders and/or account information (as shown and discussed in connection with FIG. 2). As shown in step 20, the user selects the option to create a new order or update a saved order. At step 30, the web client may then display a form page and request that the user input some basic and general information for the order, such as the name and contact information for the customer (e.g., the individual organizing the funeral), the name of the deceased individual and information related to the date, time and location of the funeral service. In certain embodiments, such as where the user is continuing or updating a saved order, the web client may populate one or more form fields with information previously input by the user. After inputting or updating the information, the user may click a button to proceed to the next part of the order. In certain embodiments, the web client may save the user's input and selections to a storage medium when the button is clicked. In other embodiments, the web client may save this information immediately after the selection is made or the information is inputted by the user. In certain of these embodiments, the web client may determine whether one or more required fields have been selected or input by the user when the button is pressed and, if not, prompt the user to input or update the information for these required fields.

After the user has input or updated the general information for the order, at step 35 the web client may display a page showing all of the available funeral and memorial related products and services and allowing the user to select a product or service to add to the order. In certain embodiments, such as where the user is updating a previously saved order, the page may also display, and allow the user to select, any of the products and services that have previously been added by the user. In certain of these embodiments, the page may include information for each of the available products and services, such as descriptions and sample images. In certain embodiments, the page may include links to one or more other web pages containing detailed information about the available products and services. At step 40, if the user wishes to add a new product or service to the order, the web client will receive and save the user's selection in step 41 and flow proceeds to step 51. Otherwise, at step 50, the user may select a previously added product or service to update, in which case flow proceeds directly to step 51.

At step 51, the web client may display a page of predefined templates that are available for the selected product or service, and present other options that permit a user to customize a selected product or service. For example, the user may be given the option of selecting from among various styles, themes and layouts for the product or service. In certain embodiments, the page may include an option for users to create their own template and/or select a default template for the product or service. After the user has selected a template and any associated options, such as style and layout, the web client may allow the user to select from among certain predefined content options, such as text, images, backgrounds, music and videos, that can be included with the product or service. In certain of these embodiments, the user may be given the option to input or upload custom content and/or modify one or more of the predefined content options to personalize the selected product or service. For example, the user may upload a picture of the deceased individual, a background image, a favorite song, a poem or hymn, or a video. As another example, in response to the user selecting a predefined text option, the web client may prompt the user to personalize the text, such as by inputting the deceased individual's name or a custom message. In certain of these embodiments, the predefined content may be modified or generated by the web client, at least in part, in response to the general information provided when the user created the order. In addition to the above, the user may be presented with a barcode option that permits a user to specify whether a QR code should be included with a selected product or service. The user may also be presented with a customization interface that permits a user to create a QR code and customize features of the QR code.

In certain embodiments, the web client may display a representation of the product or service on the web page. After the user makes a selection, such as a template, style, layout or content, or inputs or uploads content, the web client may update the representation to reflect the user's selection or input, thereby allowing the user to view changes to the product or service in real-time. Once the user has finished making selections and inputting content, at step 52 the web client saves the selections and content for the product or service. As shown in step 53, the web client may then check the product or service to determine whether one or more required items have been selected or input by the user. If not, the web client may return to step 51 and prompt the user to input or select any such missing fields. Otherwise, the web client returns to step 35, where the user can opt to add other products and services to the order and/or update any previously selected products and services.

After the user has added and updated all of the desired products and services for the order, the user may click a button to complete the order and proceed to step 60. As shown in step 60, the web client may create samples of one or more of the selected products and service and provide them to user to confirm their accuracy. In certain embodiments, the web client may generate sample files, such as Adobe PDFs, for each of the selected products and services and display the files on one or more web pages. In other embodiments, the web client may include an embedded application that allows the user to view and browse through the samples. In yet other embodiments, the web client may email the sample files to the user for confirmation.

At step 70, the web client may prompt the user to confirm that the order is complete, e.g., that the samples for each of the products and services are accurate and/or that the user has selected all of the desired products and services. Once the user has confirmed the order, at step 80, the web client may accept payment for the order from the user and then allow the user to submit the order for processing, at step 90. In certain embodiments, the web client may require payment form the user, such as a credit or debit card or token payment, prior to allowing the user to submit the order. In certain of these embodiments, the web client may direct the user to a third-party website to process the payment. In other embodiments, such as where the user is a funeral home or repeat customer, the web client may generate an invoice to be mailed to the user or flag the transaction for invoicing the user at a later time.

In certain embodiments, as discussed above, the web client may not be accessible to the end customer (i.e., the person organizing the funeral) but, rather, only to funeral homes and other similar organizations assisting the end customer with the funeral. In certain of these embodiments, as shown in FIG. 2, the web client may provide additional functionality related to managing the user's web client accounts and viewing, updating and generating reports associated with orders entered and/or submitted by the user.

FIG. 2 is a flow diagram of a process that may be used in connection with the management of user accounts and pending orders through the bereavement package ordering platform in accordance with certain embodiments. As illustrated in FIG. 2, a user may input login credentials to log into a website. At step 210, upon the submission of those login credentials to the website server, the user is granted administration access to the web client. In certain embodiments the user may be allowed to create multiple accounts, one or more of which may be associated with certain permissions. For example, a funeral home may create one “admin” account which has full permissions, including the ability to create and modify other accounts, as well as one or more general user accounts for employees with limited permissions, such as only the ability to enter and submit orders. Once logged in the user may be presented with various options, such as the opportunity to create or modify user accounts, view previous orders made by the user, filter the orders (e.g., by status, date, customer, etc), generate reports, and view or update saved or pending orders.

At step 220, if the user selects the option to modify the user's accounts and/or account settings, the web client may display a page that lists all of the accounts associated with the user and allow the user to view the information and settings for each account. The user can then be given the option to update certain settings (e.g., permissions, username) for an existing account and/or create a new account. After the user has finished viewing and updating the accounts, at step 221, the web client saves the new settings and flow returns to step 220.

Otherwise, at step 230, the web client may display a page that contains a list of all of the orders previously entered and/or submitted by the user. At step 240, the user may decide to filter the order list by one or more criteria. For example the user may wish to view all of the orders submitted for a particular customer or all of the orders submitted for the last year. As another example, the user may wish to view all of the orders that are pending, awaiting confirmation, or not finalized in step 241. If the user selects the option to filter the order list, the web client updates the order list based on the criteria and flow returns to step 230. At step 250, the user may be given the option to generate a report of the order list, which may be the complete list, or a subset based on filters selected by the user in step 230. If the user chooses to generate a report, the web client may create a report using the order list and display and/or provide the report to the user in step 251. In certain embodiments, the user may be allowed to select certain information to be included or removed from the order report. Once the user has finished viewing and/or printing the report, flow returns to step 230.

If the user does not wish to generate a report, at step 260, the user may be given the option to select and view a particular order. In response to the user selecting an order, the web client may display information for the selected order, as shown in step 261. In certain embodiments, the user may be allowed to update the order. For example, as shown in step 262, the web client may determine whether the selected order has not been finalized or has been finalized but not confirmed (e.g., samples are awaiting approval). If so, at step 263 the user may be prompted to continue, confirm or cancel the order. If the user wishes to update and/or confirm the order, the web client may allow the user to continue the order process in accordance with the steps illustrated and described in FIG. 1. Alternatively, the user may select an option to cancel the order. At step 264, the web client saves any changes made by the user and updates the status of the order and flow returns to step 230. At step 270, the user may logout and end the session.

### Exemplary Products and Services

In certain embodiments the web client may provide users with the option to select one or more of the funeral and memorial related products and services listed below. The examples below are provided for illustration purposes only. It will be understood by one of ordinary skill in the art that various other products and services may be used in addition to, or instead of, one or more of the following products and services.
Order of Service Cards—Cards distributed at funerals or similar services that provide information regarding the order of the service, such as a program. In certain embodiments, a user may be able to select, among other things, the size and layout of the cards (e.g., single sheet, folding card, or multi-page booklet), the background image or theme, the color and font of the text, the parts of the service (e.g., processional, hymn, obituary, eulogy), and the number of cards required. In certain embodiments, the user may personalize the card with a photo of the deceased.
Attendance Cards—Cards that allow attendees of a funeral or memorial service to fill out their name and address in order to let the person organizing the funeral know they attended the service. In certain embodiments, the user may be able to select, among other things, the size and layout of the card, the background or theme, the number of cards, and the color and font of the text and/or include an uploaded image. In certain of these embodiments, one or more of these features may be automatically determined based on one or more selections for the order of service cards.
Thank You Cards—Cards that allow the person organizing the funeral or memorial to send a thank you note to the attendees of the service. In certain embodiments, the card may be a folding card (e.g., greeting card) with a background or image on the front and blank inside. In certain of these embodiments, the background may be automatically set based on the theme selected for the cards above. In certain other embodiments the user may be able to select or input certain text, images or other graphics to include on or inside the card.
Envelopes—In certain embodiments, envelopes may be included for each of the types of cards selected by the user (such as the three types of cards above). In certain embodiments, the envelopes may be automatically generated and/or selected based on the selections associated with the cards. In certain other embodiments, the user may be able to select certain features, such as size, shape, color, etc., and personalize the envelopes with text and/or images.
Condolence Book—A book that allows individuals attending a funeral or memorial service, a wake, or a similar service, to write a message to the family members or individuals organizing the service. In certain embodiments, the book may be a hardcover book with preformatted pages that indicate where to include a message, as well as other information such as name and address, etc. In certain embodiments, the user may be able to select various options associated with the book, such as size, number of pages, format of the pages, and color and background for the pages. In certain of these embodiments, the user may also be able to choose a predefined cover and/or upload a photo or image to include.
Memorial Photo Album—An album including various photographs, which may be uploaded by the user, such as pictures of the deceased, family members, and friends. In certain embodiments, the user may select from among various options such as the size, shape and layout of the album, the order of the photographs, the number of albums, and the format of the cover. In certain embodiments, the user may be able to order a “flipbook” version (e.g., a smaller, soft-cover album), which could be provided to each of the attendees at the funeral or memorial service. In certain embodiments, the user may be given the option to make the photographs available online (e.g. at, or linked to, a memorial website as discussed below), such as in the form of an electronic photo album.
Memorial DVD—A DVD or CD of photographs and/or videos, which may be uploaded by the user. In certain embodiments, the user may be able to select the format of the DVD or CD, including the order of the photographs and videos and the playback format (e.g., slideshow). In certain of these embodiments, the user may be provided the option to select or input certain audio files (such as songs or hymns), such as to play during playback of the photos and/or videos. In certain embodiments, the user may also have the option of making a slideshow and/or video available online.
Keepsake Box—A memorial box or similar container. In certain embodiments, the box may contain one or more of the other products ordered by the user and allow such products to be delivered to the person organizing the funeral as a single bereavement package. The box may then be used by such individuals as a memorial box, such as to store photos of, or items belonging to, the deceased individual or keepsakes from the funeral service. In certain embodiments, the user may be able to select various options for the box, including the shape, size, and color of the box, and the image, background, or photograph for the box lid. In certain of these embodiments, one or more of these options may be automatically selected based on the products ordered by the user.
Memorial Website—A remembrance website for the deceased individual. In certain embodiments, the user may be able to select from among certain predefined templates, themes, and/or layouts, and/or upload various backgrounds, images, audio, etc. for the website. For example, the website may include a photo of the deceased individual and a eulogy and/or message from the family. In certain embodiments, the website may allow visitors to post messages on the web page (e.g., on a message board), such as to give their condolences to the family, or share stories or their experiences with the deceased individual. In certain of these embodiments, the user may be given the option to receive a hard copy of the messages and/or other portions of the website after a specified period of time. In certain embodiments, the website may be integrated with, or connected to, one or more social media websites (e.g., Facebook or Twitter). In certain embodiments, the website may include a page, or a link to, various other content, such as a photo album or videos of the deceased. In certain embodiments the website may include information regarding the funeral or memorial service, wake and other similar services, as well as other information, such as a charity that the family is requesting that any donations be provided to. In certain of these embodiments, visitors to the website may be able to make a donation to the charity directly through the website. In certain embodiments, visitors to the website may be able to order certain products to be sent to the individual organizing the funeral or to be sent to the location of the service, such as flowers or cards. In certain embodiments, the user may be able to select the domain name where the website is to be located. In other embodiments, the domain name may be automatically generated and/or may be a sub-domain within a vendor's website.
Remote Access/Interactive Service—A service through which people who are unable to attend the wake, funeral, or other memorial service may view and/or “attend” the service. In certain embodiments, a video screen or similar display may be provided at the memorial service. In certain of these embodiments, one or more audio and/or video messages may be displayed on the screen, such as images or video messages from individuals who are unable to attend the service. In certain embodiments, such individuals may be able to remotely access the screen to provide such messages in real time and/or interact with the individuals present at the service. In certain embodiments, individuals may be able to input or upload a message, image and/or video through a memorial website (as discussed above) and select an option to have the message displayed on the screen during the service.
E-Cards—Various forms of electronic cards, such as a funeral or memorial service notice, or thank you card may be provided as an option to the user. For example the person organizing the funeral or memorial may want to send an e-mail to a group of recipients with a notice including information about the funeral service. As another example, the individual may want to email a thank-you card to the attendees of the service. In certain embodiments, the user may select the theme, layout and customize and/or upload certain content to include on or with the e-cards. In certain embodiments the e-cards may be provided to the individual immediately (such as via download, or e-mail). In certain other embodiments, the user may upload a distribution list and the e-card could be delivered to the recipients automatically. In yet other embodiments an e-card or similar greeting could be automatically sent to one or more recipients periodically, such as on the anniversary of the passing of the deceased.

It should be noted that a user may include or provide a QR code in conjunction with any of the products and services listed above, as well as any other product or service that may be associated with a bereavement package.

### Administration Client

As discussed above, according to certain preferred embodiments, the web-based software platform and corresponding systems and methods are provided and operated by a single vendor, such as a printing company, that is capable of creating and manufacturing each of the products and services offered through the platform and delivering such products and services to the individual organizing the funeral. In certain of these embodiments, the vendor may utilize a plurality of facilities, such as printing hubs, each of which service individuals from a certain geographic area or locale. In certain other embodiments, the vendor may utilize one or more third party companies to provide one or more of the products or services and handle the order and delivery of such products and services to the individual.

In certain embodiments, the orders placed by users through the web client are received at a central web server operated by the vendor. As will be appreciated by one of skill in the art, in certain embodiments, the “central web server” may comprise various hardware and software architecture, including a plurality of web servers, for, among other things, receiving and processing the orders from web clients. In certain of these embodiments, such as where the vendor operates a plurality of printing hubs, the central web server may automatically forward the orders to the appropriate printing hub, based on certain information, such as the address of the individual receiving the products and services. In other embodiments, the order may be submitted directly to the appropriate printing hub without going through the central server.

According to certain embodiments, the web-based software platform and corresponding systems and methods include a bereavement package processing platform which may be accessed by the vendor (and/or the printing hubs) through an administration client to facilitate various tasks. In certain embodiments, the administration client may provide features and functionality associated with the administration and management of admin and customer accounts, creating customized web clients, processing and tracking orders and processing payments and invoicing, as discussed above. In certain of these embodiments, the administration client is accessible only to the vendor and/or the printing hubs, and their respective employees, representatives, etc.

According to certain embodiments, a user preferably accesses the administration client through a website service showing various pages to provide the user with these features. In certain embodiments, the user may have and/or be required to have a user account in order to login to the administration client. In certain embodiments, the administration client may include one or more types of accounts, such as accounts providing access to all or a limited set of the features available through the administration client. For example, there may be one type of account (e.g., “admin”) which has full access to all of the functionality, including creating, deleting and modifying other accounts, a second type of account (e.g., “customer management”) which only has access to the features related to the creation and modification of customer accounts for the web client and/or the creation of customized web clients, and a third type of account (e.g., “order processing”) which only has access to the features related to viewing, updating and generating reports for the received orders.

After the user's login information has been authenticated, the user may be presented with a number of options. In certain embodiments, such as where the user has administrative permissions, one such option may be to view, create, update and/or delete the user accounts for the administration client. Another option may be for the user to view, create, update and/or delete customer accounts. In certain of these embodiments, the user may be presented with one or more web pages listing the existing accounts and may have the ability to view an existing account, create a new account and/or delete or modify an existing account. In certain embodiments, the user may be prompted to input certain information and make selections through a web page that includes various form fields and menus. Once the user has finished inputting the information, the administration client may check whether one or more required fields have been input or selected and, if so, save the new or updated account.

According to certain of these embodiments, in connection with creating or modifying a customer account, the user may have the ability to specify whether the customer will use the generic web client or a customized web client. If the user selects a customized web client, the user may be able to create and design the web client through the selection of one or more options, such as choosing templates, themes, and layouts for the web client and/or inputting or uploading various content, including logos, background images, text, etc. For example, in the case where the customer is a funeral home or funeral home group, the web client could be customized to include the company or group's name and logo. As another example, the web client could be customized to limit the products and services to a subset of those offered through the generic client. As yet another example, the web client could be created such that it is located at, or redirects from, a web page on the customer's website.

In certain embodiments, the administration client may also allow the user to view and update the orders received from the web client's, filter the orders by various criteria, and or generate various order reports. For example, the user may be given the option to view all newly received orders, such as to distribute the orders for processing. Likewise, the user may be able to view all orders by a certain customer, having a certain status, or within a specified date range. In certain embodiments, the user may be able to modify certain information associated with a particular order, such as to change the order, or update its status. In certain embodiments, the user may also be able to generate various types of reports associated with one or more of the orders.

In certain embodiments, the user may be able to utilize the administration client to track and manage payments from customers. For example, the user may be able to see whether payment has been received for a particular order or orders and/or update the order status from “awaiting payment” to “processing” when payment is received. In certain embodiments, such as where a customer has selected an option to be billed for one or more orders, the user may be able to generate an invoice for all outstanding orders submitted by the customers. In certain of these embodiments, the invoice may be automatically generated by the administration client, such as on a period basis.

According to certain embodiments, the administration client may also provide the ability to manage and update the products and services offered through one or more of the web clients. For example, a user of the administration client may be able to add a new type of product or service or modify or delete an existing product or service offered through all or a subset of the web clients.

In certain embodiments, as described above in connection with the web client, the administration client may offer an enhanced, user-friendly platform in the form of a graphical wizard that steps users through the various features and options, such as to assist users in managing, creating and updating, user accounts, customer account and custom web clients.

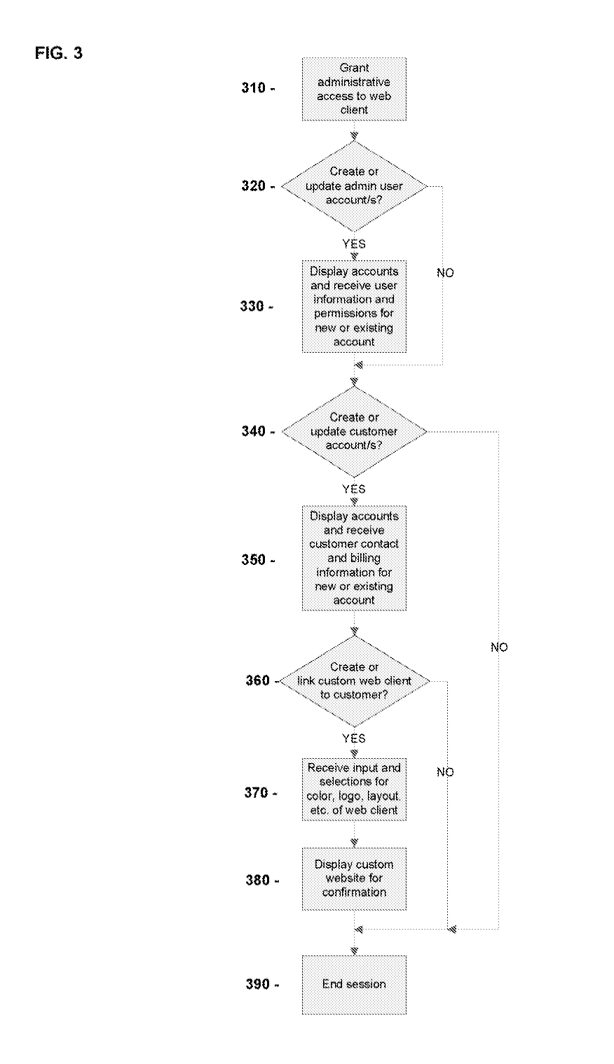

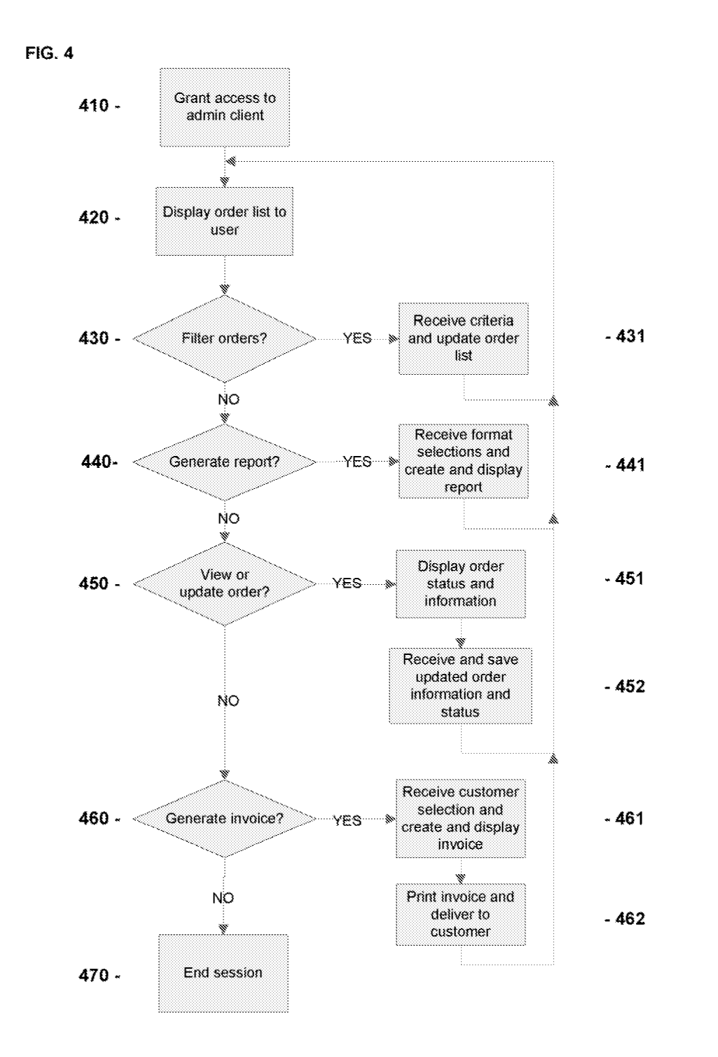

FIGS. 3 and 4 illustrate various exemplary steps involved in the management and creation (and modification) of user accounts, customer accounts and custom web clients and the management and processing of orders and billing, in accordance with certain embodiments. FIGS. 3 and 4 are provided for purposes of illustration only, and it should be understood that one or more of the steps shown therein may be removed, replaced, repeated, performed in an alternate order and/or other steps may be included.

FIG. 3 is a flow diagram of a process that may be used in connection with the management and creation of user accounts, customer accounts and custom web clients through a bereavement package processing platform in accordance with certain embodiments. As shown in FIG. 3, a user may input login credentials to log into a website. Upon the submission of those login credentials to the website server, the user is granted access to the administration client as shown in step 310. Once logged in the user may be presented with various options, such as the opportunity to update user accounts for the administration client and view or update customer accounts and/or custom web clients. In certain other embodiments, the user may also be presented with the opportunity to view and process orders and/or order billing (as shown and discussed in connection with FIG. 4). As shown in step 320, the administration client may determine whether the user wants to view or update the user accounts. For example the web page may include a button or link to allow the user to access this feature. If not, flow proceeds to step 340. Otherwise, at step 330 the administration client may display a web page which includes a list of all of the existing user accounts. The user can then view and modify the information for an existing account or select an option to create a new account. In certain embodiments, the information for the account is displayed to, and/or input by, the user through various form fields and menus included on the web page. After inputting or updating the user account information, the user may click a button to save the changes to the account. In certain embodiments, the administration client may then save the user's input and selections to a storage medium. In certain of these embodiments, the administration client may determine whether one or more required fields have been selected or input by the user and, if not, the administration client may prompt the user to input or update the information for these required fields.

At step 340, the administration client may determine whether the user wants to view, create or update one or more customer accounts. If not, flow proceeds to step 90 at which point the user's session ends. Otherwise, at step 350 the administration client may display one or more web pages that list the existing customer accounts. In certain embodiments, the user may view the information for a particular account by selecting or clicking on that customer. The user may then modify the information in or, in certain cases, delete the customer account. In certain other embodiments the user may wish to create a new customer account and, in response, the administration client may display a web page with various form fields and menus and prompt the user to select and/or input certain general information for the new customer. In certain embodiments, the user may be given the option of linking the new customer to another, previously entered customer. For example in the case where the new customer is a member of a funeral home group or similar organization that already has an existing customer account the user may be able to specify that the new customer is a part of this group. After the user has finished selecting and inputting various information, the user may click a button to save the new customer (or the update to an existing customer). As discussed in connection with user accounts, the administration client may determine whether certain required information has been provided by the user prior to saving the new or updated account.

At step 360, the administration client may determine whether the user wishes to create or update a custom web client for the customer, such as by prompting the user when the new or updated customer account is saved, or by allowing the user to select a “custom web client” option during customer account setup or modification. If the user does not want to create or update a custom web client flow proceeds to step 90 and the user's session ends. Otherwise, the administration client may display one or more web pages that allow the user to customize a web client for the customer by selecting various templates, layouts, colors, styles, interfaces, etc. and uploading images and other content to be used on the web client. In certain embodiments, the administration client may present the user with a “wizard” type interface to create or modify the web client as discussed above in connection with the web client.

In certain embodiments, such as where the customer is part of a larger funeral home group or other organization, the user may be able to specify that the customer be granted access to, or use the same web client as the rest of the members of the group. In certain other embodiments, the user may allow the customer to personalize the web client by giving the customer access to that feature of the administration client. In certain embodiments, the user may be able to select the domain name where the web client will be located. In other embodiments, the location may be automatically generated by the administration client.

After the user has customized or updated the web client, the administration client may provide the user with a link to access and review the customized website, as shown in step 370. The user is thereby able to confirm that the web client was created properly and, upon receiving confirmation the administration client may save the customized web client and associated customer account. At step 380, the user can view the custom website for confirmation. At step 390, after the user has finished managing the user accounts and customer accounts and custom web clients, the user may logout and end the session.

FIG. 4 is a flow diagram of a process that may be used in connection with the management, processing, fulfillment, and billing of orders for personalized bereavement packages through the bereavement package processing platform in accordance with certain embodiments. As illustrated in FIG. 4, a user may input login credentials to log into a website. At step 410, upon validation of those login credentials at a website server, the user is granted access to the web client. Once logged in the user may be presented with various options, such as the opportunity to view, process and/or update orders, filter the orders (e.g., by status, date, customer, etc), generate reports and/or invoices.

If the user selects the option to manage orders, at step 420 the administration client may present one or more web pages that display a list of all of the orders received via one or more web clients. At step 430, the administration client determines whether the user wants to filter the order list by one or more selectable criteria. If not, flow proceeds to step 440. Otherwise, at step 431, the user may be provided with one or more options that can be selected to narrow the list of orders. For example the user may wish to view all of the orders received from a particular customer or all of the orders that are “in-progress” or “awaiting approval.” If the user chooses to filter the order list, the administration client receives the criteria selected or input by the user, updates the order list based on the criteria and flow returns to step 420, where the updated order list is displayed.

At step 440, the administration client may determine whether the user wants to generate a report, such as a report summarizing certain information for the current displayed order list, which may be based on one or more filters selected by the user in step 430. If the user chooses to generate a report, at step 441 the web client may create a report using the order list and display or provide the report to the user. In certain embodiments, the user may be allowed to select certain information to be included or removed from the order report and/or choose the format, layout, etc. for the report. Once the user has finished viewing and/or printing the report, flow returns to step 420.

If the user does not wish to generate a report, at step 450, the administration client may determine whether the user has selected a particular order from the displayed order list. If not, flow continues to step 460 Otherwise, in response to the user selecting a particular order, the web client may display certain information for the selected order, as shown in step 451. In certain embodiments, the user may be allowed to modify, update or cancel the order. For example, the user may want to update the status of the order to “out for delivery” after the bereavement package has been mailed to the user. As shown in step 452, after the user has finished updating or deleting the order, the administration client may save any changes made by the user and flow returns to step 420. In certain of these embodiments, the administration client may generate one or more automatic alerts, such as e-mails or text messages that are delivered to the person organizing the funeral or the funeral home that indicate the status of the order.

At step 460, the user may be prompted to generate an invoice or manage billing for a customer. If not, flow proceeds to step 470 and the user's session ends. Otherwise, at step 461 the user may view the billing information for a particular customer or customer group, including all of the orders that have not been billed and/or paid. In certain embodiments, the user may select from among various options with respect to the format of the invoice and request that the administration client generate an invoice for the customer. In response, at step 462 the administration client may create an invoice based on the user's selections and input and may display the invoice to the user in a web page and/or allow the user to download and print the invoice. In certain of these embodiments, the administration client may generate and/or deliver the invoice to the customer automatically via e-mail, text message, etc., such as on a monthly or periodic basis. After the user has finished managing invoices, as well as orders and reports, the user may log out at step 470 and end the session.

### Exemplary Web Client

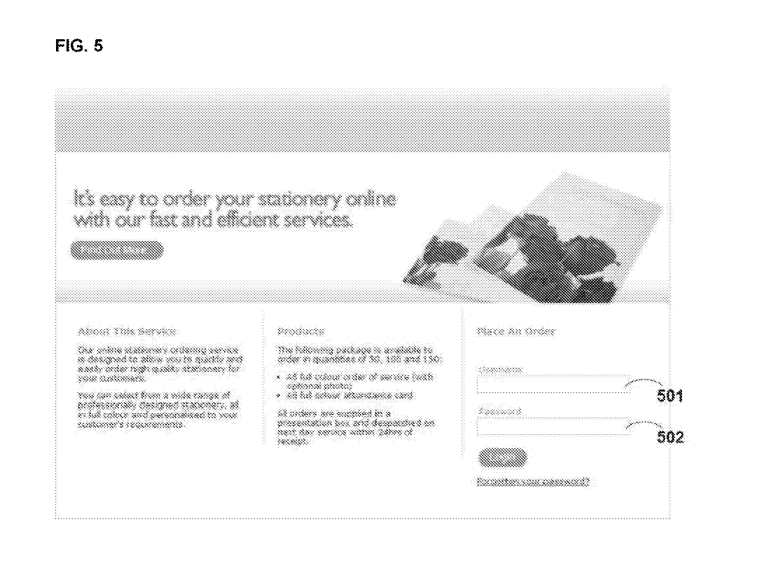

The following is one example of a web client in accordance with the principles of the present invention. More specifically, FIGS. 5-24 and the corresponding descriptions below illustrate and describe certain exemplary web pages and related content, features and functionalities associated with the web client accessed through the bereavement package ordering platform and corresponding systems and methods described herein. These examples are provided for the purposes of illustration and the present invention is not limited to the general functionality, topics and screenshots shown herein. Variations and modifications can be made in the form of additional exemplary embodiments that are not illustrated in the discussion of the figures below.

FIG. 5 is a pictorial diagram illustrating a portion of the display of a web client having a user login page presented to users in connection with accessing the bereavement package ordering platform, according to certain embodiments. As shown in FIG. 5, in certain embodiments, the user may login by inputting a user name 501 and password 502, or the user may sign up or fill out an application (e.g., a web form) for an account. In certain other embodiments, the user may only need to log in to use certain restricted features (e.g., orders).

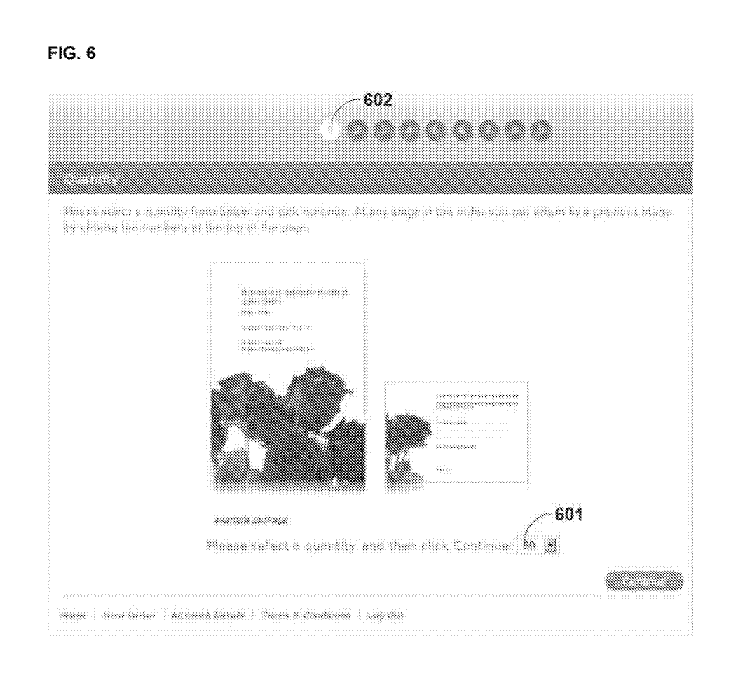

FIG. 6 is a pictorial diagram illustrating a portion of the display of a web client having an order quantity selection page accessed by users through the bereavement package ordering platform, according to certain embodiments. As shown in FIG. 6, in certain embodiments, if the user chooses to create a new order, the user may be presented with a first page asking the user to choose the quantity of certain products 601, such as corresponding to the expected number of guests at the service. As discussed above, while creating the order, the web client may display a progress bar 602 (illustrated in FIG. 6 in the form of a highlighted row of numbered steps that updates as the user progressed through the order.

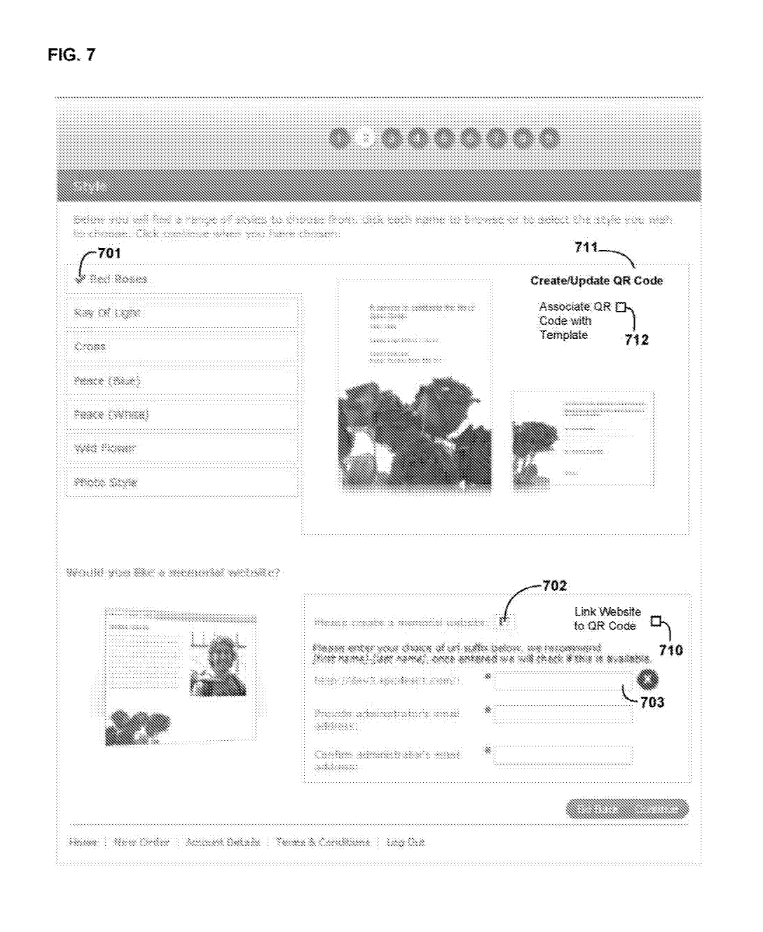

FIG. 7 is a pictorial diagram illustrating a portion of the display of a web client having a theme selection page accessed by users through the bereavement package ordering platform, according to certain embodiments. As shown in FIG. 7 the theme selection page may present users with a range of styles or templates for one or more of the products or services. In certain embodiments, the user can choose a style or template for one or more of the products or services, such as the “red roses” style 701. By selecting option 712 (labeled “Associated QR Code with Template”), the user can link the products and services associated with a selected template to a QR code that has been created. If the option 712 is selected, a QR code may be included as part of the template and thus may be included with all or some of the products or services to which the template is applied. If a QR code has not been created (or if the user wishes to update or customize settings with a created QR code), the user may select option 711 (labeled “Create/Update QR Code”). By selecting this option 712, the user may be presented with an interface that permits the user to create a QR code and/or to customize features of an existing QR code.

The user may also be able to select one or more services, such as a memorial website 702. In certain embodiments, as illustrated by 703, the user may be able to select the URL for the website. The user may also be able to select an option 710 (labeled “Link Website to QR Code”) for associating or linking the website and URL with a QR code that has been created for a bereavement package. If the user selects the option 710, then the URL for memorial website may be embedded into a QR code. In certain embodiments, scanning or reading the QR code with a QR reader application on a mobile device (or other type of device) may cause a browser to be launched on the mobile device and the browser would automatically display the memorial website identified by the URL.

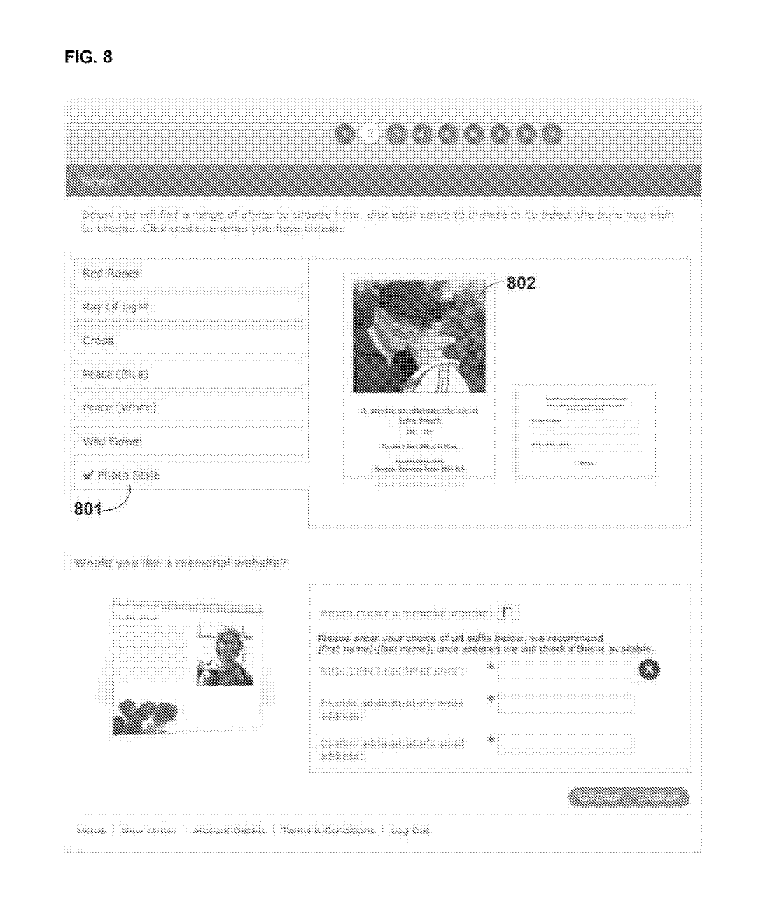

FIG. 8 is a pictorial diagram illustrating a portion of the display of a web client having a theme selection page accessed by users through the bereavement package ordering platform, according to certain other embodiments. As shown in FIG. 7 and FIG. 8, in certain embodiments, the user can choose from among certain predefined styles or templates or, as illustrated in FIG. 8, may choose a personalized style such as a “photo style” 801 and upload a photo 802 to use on one or more products and services. Although it is not illustrated in FIG. 8, the QR code features illustrated in FIG. 7 (i.e., options 710, 711 and 712) may also be incorporated into the interface shown in this figure.

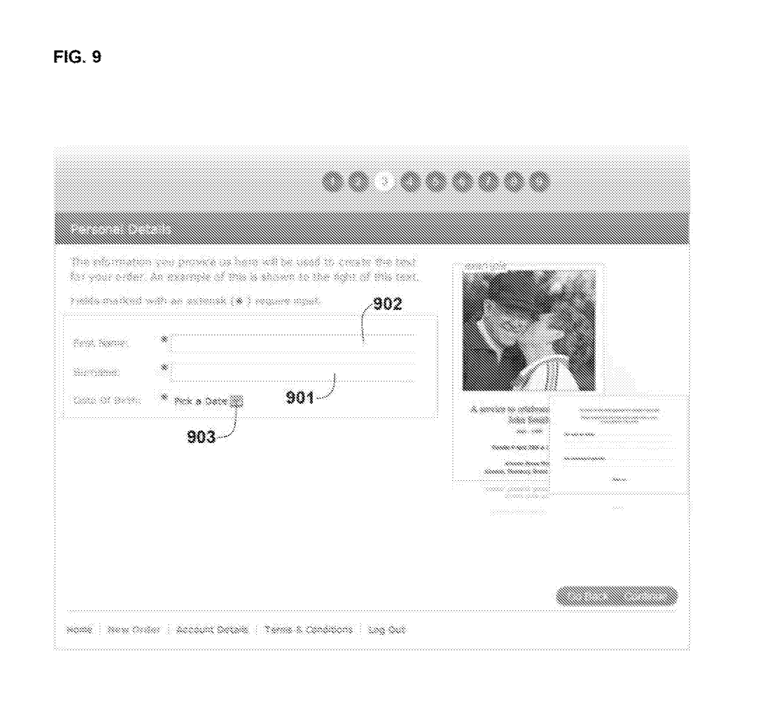

FIG. 9 is a pictorial diagram illustrating a portion of the display of a web client having a deceased individual information page accessed by users through the bereavement package ordering platform, according to certain embodiments. As shown in FIG. 9 the deceased individual information page may present users with various fields for inputting personal information associated with the deceased individual. In certain of these embodiments, the user may be prompted to input and/or select certain information for the deceased individual, such as their name (surname 901 and first name 902) and date of birth 903. Other information may be provided by the user, such as a favorite poem or song, etc.

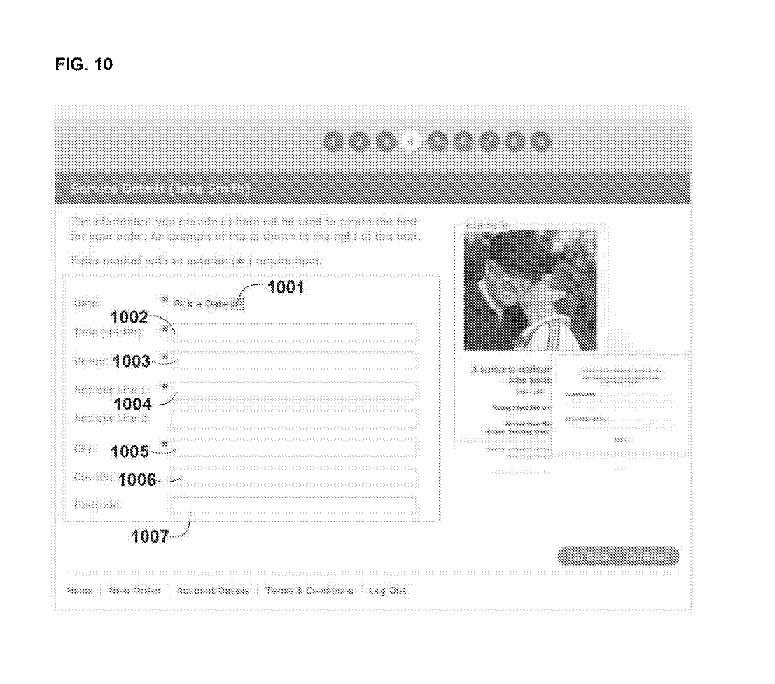

FIG. 10 is a pictorial diagram illustrating a portion of the display of a web client having a service information page accessed by users through the bereavement package ordering platform, according to certain embodiments. As shown in FIG. 10 the service information page may present users with various fields for inputting information associated with the service for the deceased individual. In certain of these embodiments, the user may be prompted to input and/or select certain information related to the funeral or memorial service, such as date 1001, time 1002, venue 1003, address 1004, city 1005, country 1006, zip code 1007. As illustrated in the FIG. 10 (as well as other figures herein) the web client may indicate certain fields that require input from the user, such as with an asterisk.

In certain embodiments, the interface illustrated in FIG. 10 may include an option (not shown) for associating the service details with a QR code. If the option is selected, a QR code included on products and services may be associated with a functionality for transmitting a text message or e-mail that includes the service details (specified by the user via the interface in FIG. 10). Thus, scanning the QR code would cause the transmission of text message or e-mail that includes the service details.

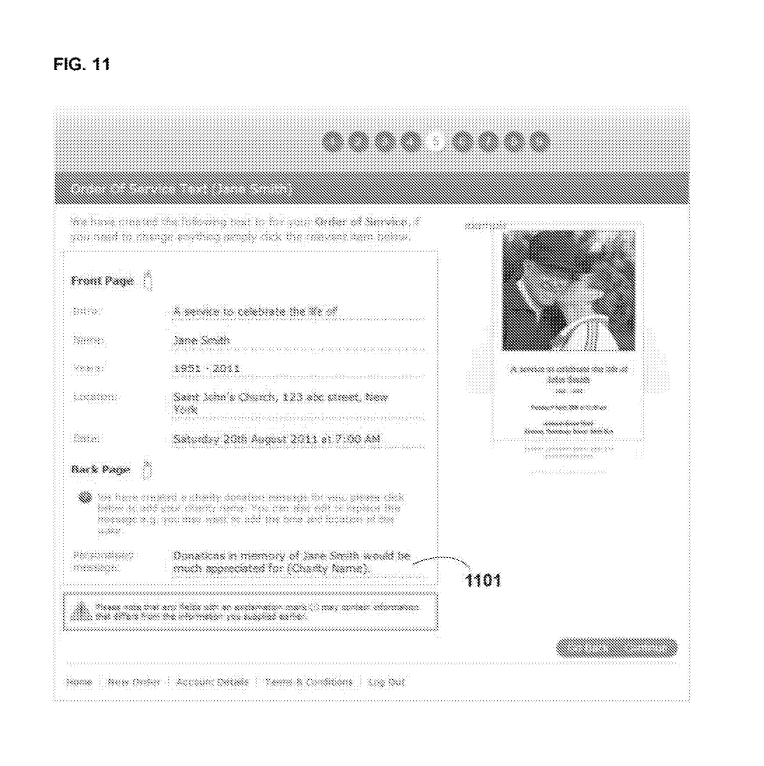

FIG. 11 is a pictorial diagram illustrating a portion of the display of a web client having a bereavement product preview page that includes auto-generated content for an order of service product created through the bereavement package ordering platform, according to certain embodiments. The bereavement product preview page may present users with text and other content associated with one or more products or services selected and/or customized by the users, such as an order of service card as shown in FIG. 11. In certain embodiments, the web client may auto-generate a portion of the text or content for one or more products or services, such as the cover of the order of service card. As shown in FIG. 11, the user may then be presented with the option to modify and personalize the auto-generated and/or other information, and add optional content, such as a charity for donations 1101. As can be seen in the images throughout FIGS. 5-11, the web client may display a running sample of one or more products or services based on the selections and/or input made by the user.

In certain embodiments, the bereavement product preview page may include an option (not shown) for including a QR code on or in conjunction with one or more products or services selected and/or customized by the users.

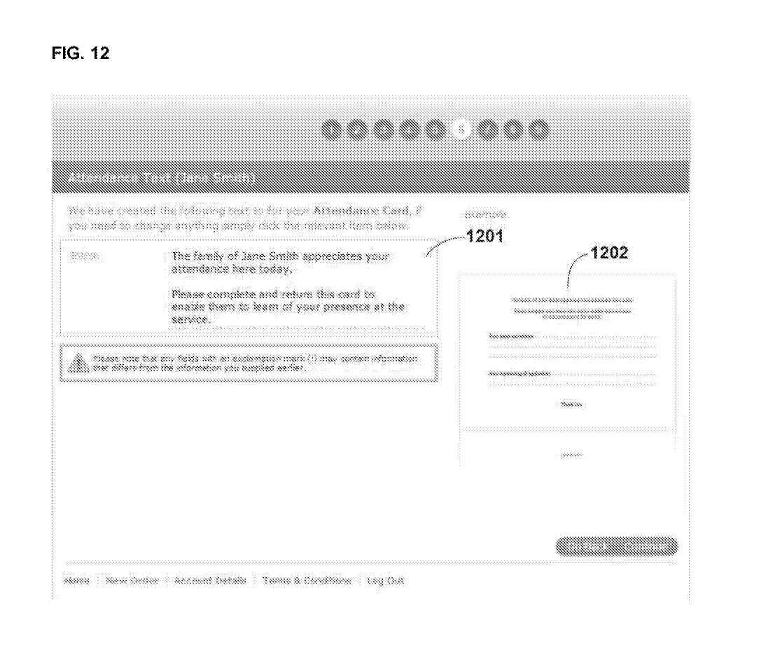

FIG. 12 is a pictorial diagram illustrating a portion of the display of a web client having a bereavement product review page that includes auto-generated content for an attendance product created through the bereavement package ordering platform, according to certain embodiments. As shown in FIG. 12 the bereavement product review page may present users with the text or other content associated with an attendance card (or sheet) 1201. In certain embodiments, the web client may display auto-generated text or other content for the attendance cards (or sheets), which the user may modify or personalize. As shown in FIG. 12, in certain embodiments, the web client may display a sample of how the card will look 1202. The card can be further updated in real-time based on the user's input and selections.

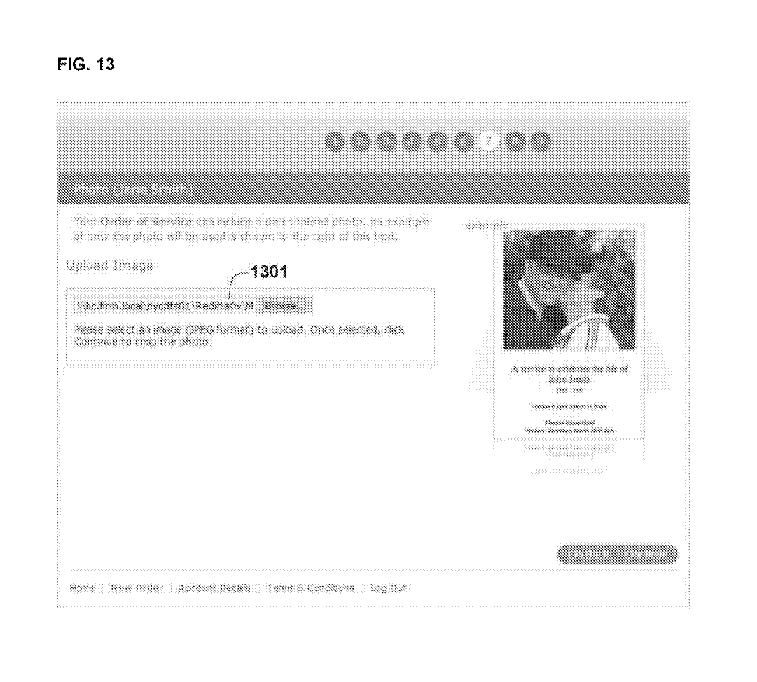

FIG. 13 is a pictorial diagram illustrating a portion of the display of a web client having a photo upload page accessed by users through the bereavement package ordering platform, according to certain embodiments. As shown in FIG. 13, in certain embodiments, the user may be given the option of uploading a photo 1301, such as where the user has selected a “photo style” or where the user wishes to include a photo within or on one or more of the selected products and/or services. In certain embodiments, the user may also, or alternatively, be able to input a link to a photo (such as a link to a third-party web album provider).

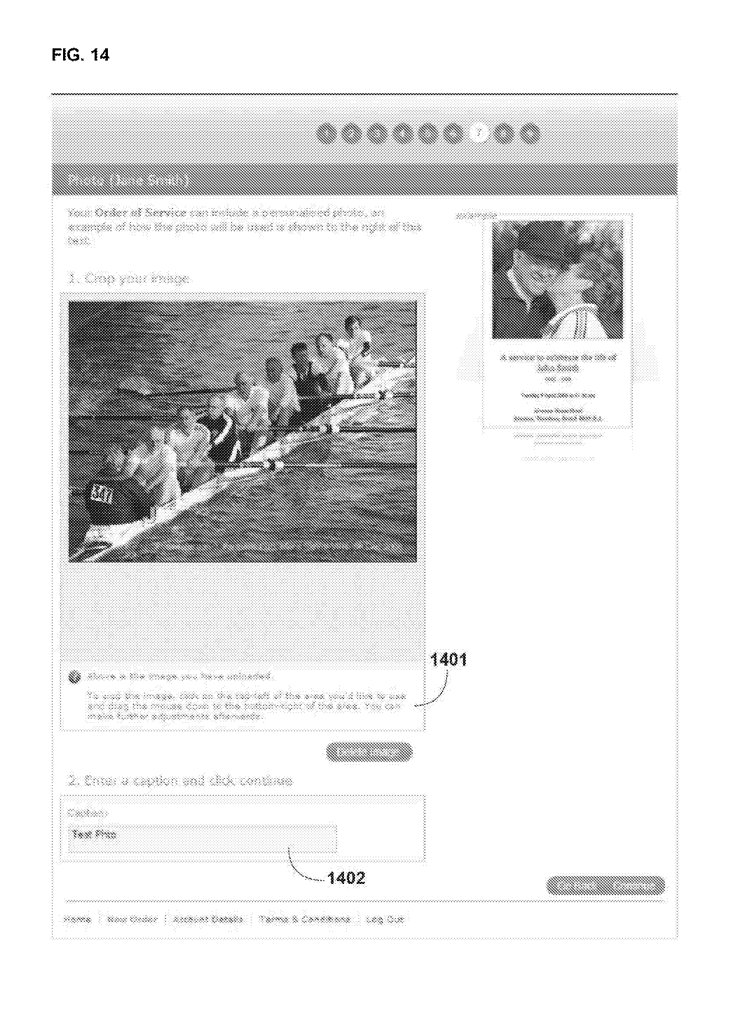

FIG. 14 is a pictorial diagram illustrating a portion of the display of a web client having a photo editing page for allowing users to edit photos uploaded through the bereavement package ordering platform, according to certain embodiments. As shown in FIG. 14, in certain embodiments, the web client may display the uploaded photo to the user and allow the user to edit the photo 1401, such as by resizing, cropping, or reformatting the photo. The user may also be able to input a name or caption 1402 for the uploaded photo.

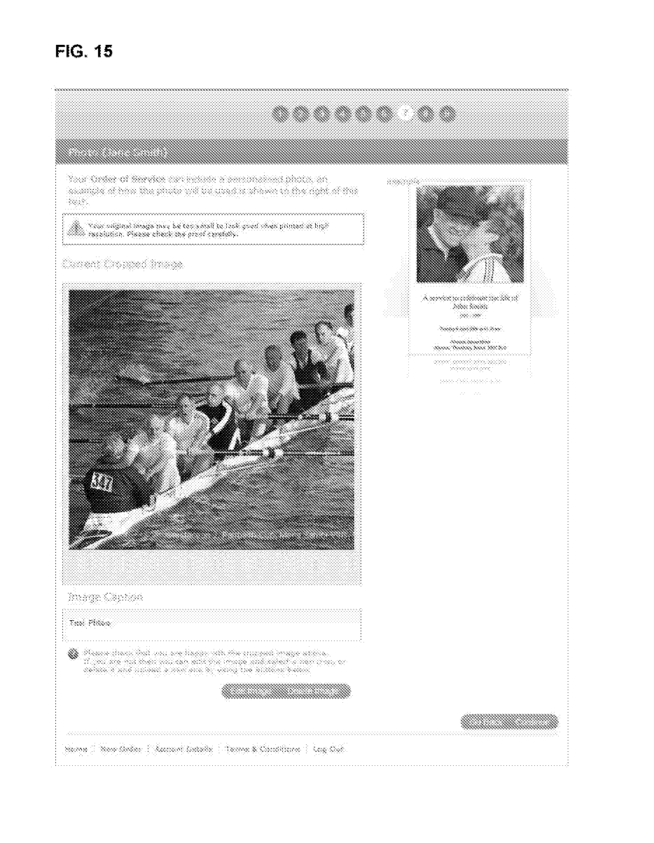

FIG. 15 is a pictorial diagram illustrating a portion of the display of a web client having a photo preview page for allowing users to preview photos edited through the bereavement package ordering platform, according to certain embodiments. As shown in FIG. 15 the photo preview page map present users with an updated display of a photo that has been uploaded and edited by the user. For example, as illustrated in FIG. 14, the web client may include a feature that allows the user to crop the uploaded photo such as to make it fit on the card or other product. The web client may display the edits to the photo in real time, as illustrated in FIG. 15.

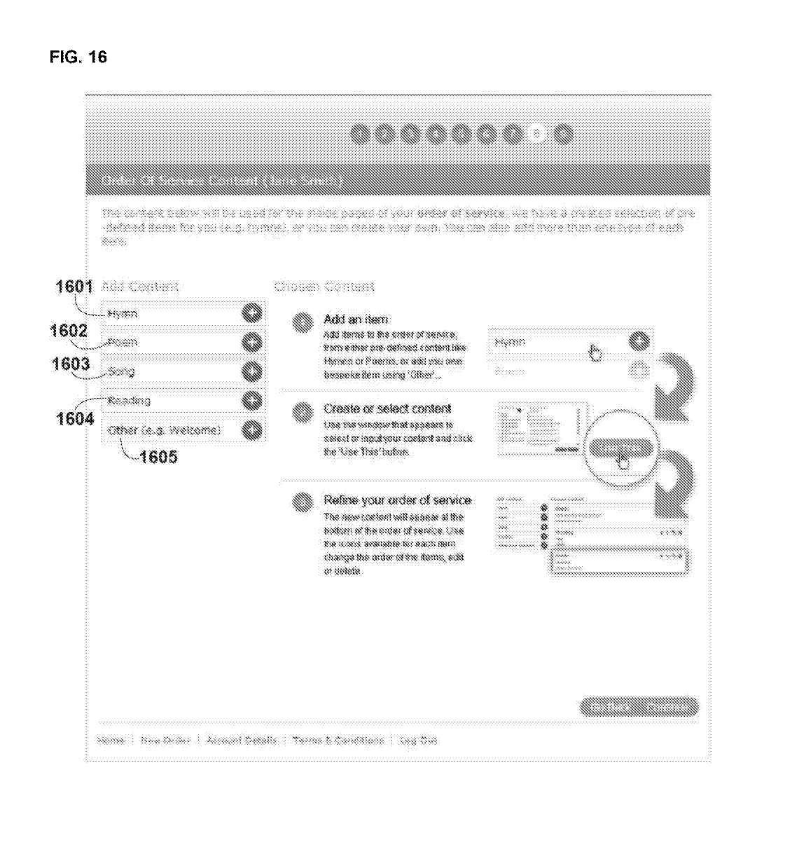

FIG. 16 is a pictorial diagram illustrating a portion of the display of a web client having a product customization page for allowing users to customize an order of service product created through the bereavement package ordering platform, according to certain embodiments. The product customization page may present users with various fields associated with the content for one or more products or services selected by the users, such as fields associated with an order of service card, as shown in FIG. 16. In certain of these embodiments, the user can customize the content for one or more products or services, such as by adding predefined content (e.g., hymns 1601, poems 1602, songs 1603, readings 1604) or inputting custom content 1605. In certain embodiments, the user can customize the content for one or more products or services by selecting an option (not shown) for including a QR code on, or in conjunction with, the one or more products or services.

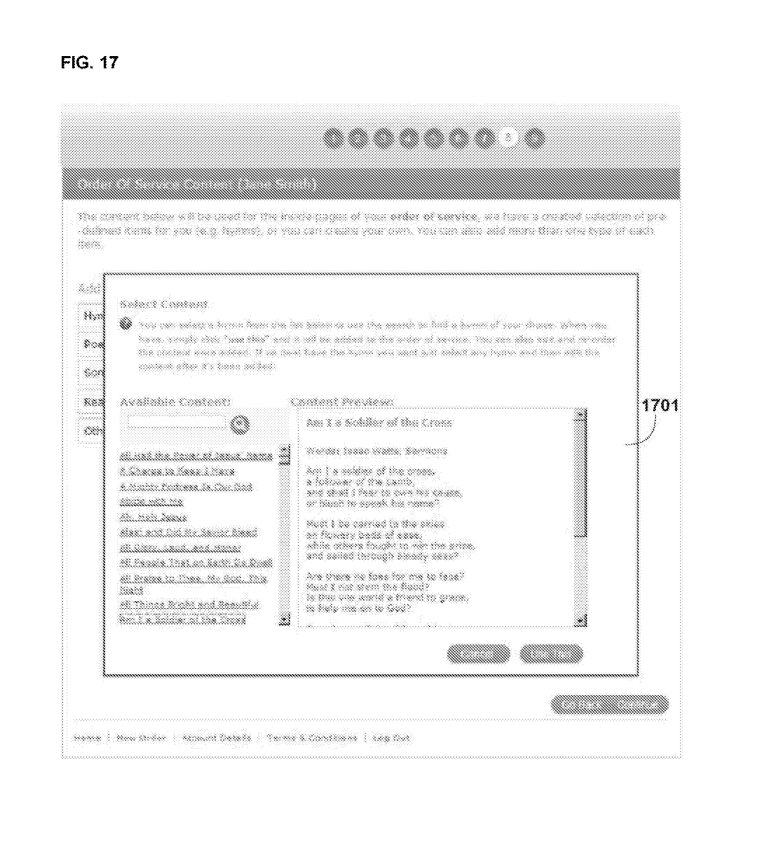

FIG. 17 is a pictorial diagram illustrating a portion of the display of a web client having a content selection page for allowing users to select a hymn to be added to an order of service product created through the bereavement package ordering platform, according to certain embodiments. The content selection page may present users with various predefined content or input fields that are associated with a particular product or service. For example, as shown in FIG. 17, in certain embodiments, the user may select an option to add a hymn to the order of service card. The web client may then display various options in a pop-up window 1701, or in the web page itself. The user may then choose one or more predefined items, or input his or her own content. The predefined items may be displayed in a list and the user may be able to click on a specific item to view the content.

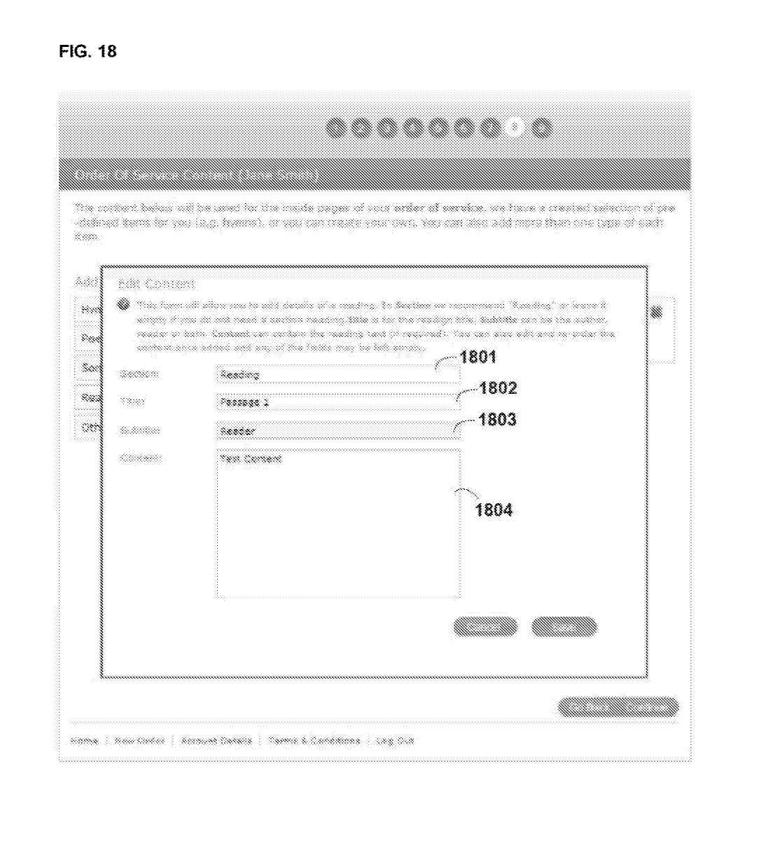

FIG. 18 is a pictorial diagram illustrating a portion of the display of a web client having content selection page for allowing users to select a reading to be added to an order of service product created through the bereavement package ordering platform, according to certain embodiments. As shown in FIG. 18, in certain embodiments, the user may select an option to add a reading 1801 to the order of service card. The user may input various information, such as the title 1802, the reader 1803, and the content of the reading 1804. In certain embodiments, the user may be able to select from a list of predefined readings.

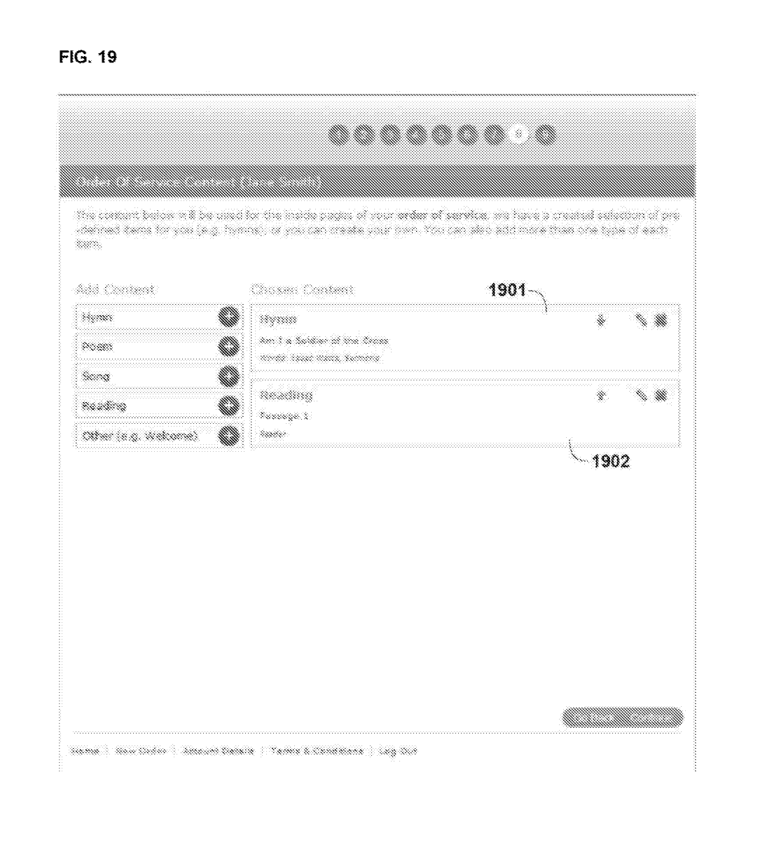

FIG. 19 is a pictorial diagram illustrating a portion of the display of a web client having a product customization page that presents users with a list of the content associated with an order of service card created through the bereavement package ordering platform, according to certain embodiments. As shown in FIG. 19, in certain embodiments, the web client may display a running list of the content added to, or selected for, a product or service. For example, the web client may display the content that has been selected for the order of service cards (such as hymn 1901 and reading 1902), and allow the user to delete, modify, and/or change the order of the content items.

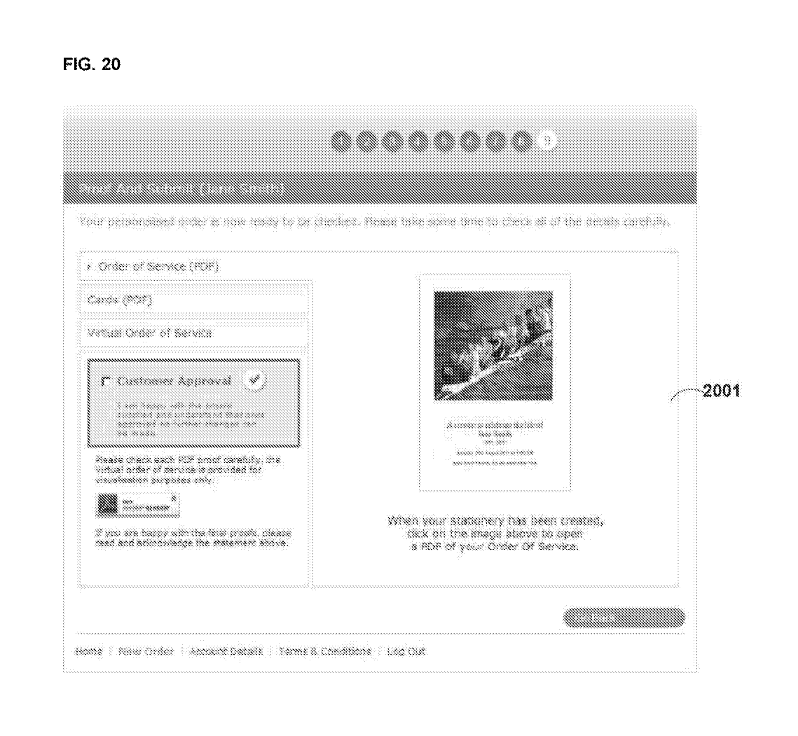

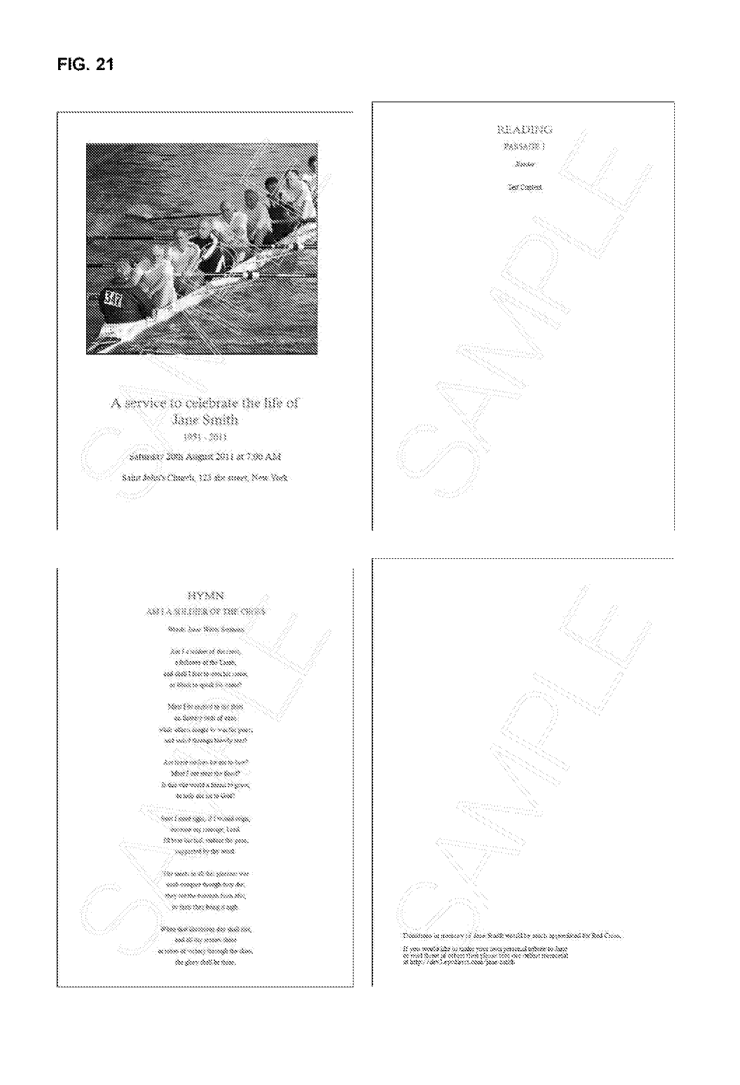

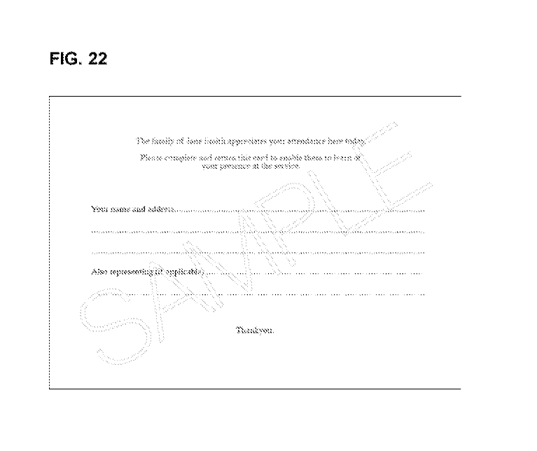

FIG. 20 is a pictorial diagram illustrating a portion of the display of a web client having a product confirmation page that allows users to preview and confirm samples of one or more products and services created through the bereavement package ordering platform, according to certain embodiments. As shown in FIG. 20, in certain embodiments, after the user has selected, modified, and personalized each of the desired products and services, the web client may generate samples for one or more of the selected products and services in real time and allow the user to view the samples (e.g., an order of service card 2001), to review and confirm their accuracy prior to submitting the order. For example, as shown in FIGS. 21 and 22, samples for one or more products and services may be generated in the form of Adobe Acrobat (pdf) files. In this regard, FIG. 21 is a pictorial diagram illustrating a sample PDF file for an order of service product created through the bereavement package ordering platform, according to certain embodiments, and FIG. 22 is a pictorial diagram illustrating a sample PDF file for an attendance card created through the bereavement package ordering platform, according to certain embodiments. In certain other embodiments, the users may be given the option to receive a copy of the sample files, such as via e-mail.

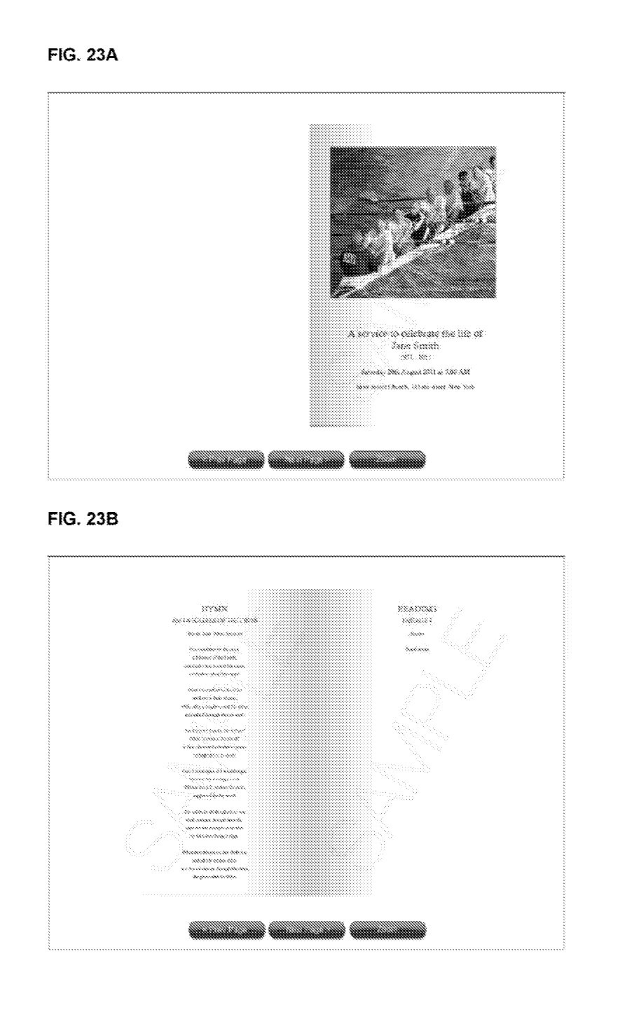

FIGS. 23A and 23B are pictorial diagrams illustrating a portion of the display of a web client having an embedded viewer that allows the user to preview samples for one or more products or services created through the bereavement package ordering platform, according to certain embodiments. As shown in FIGS. 23A and 23B, in certain embodiments, the web client may also include an embedded viewer that is designed to allow the user to view samples for one or more of the selected products and service, such as to “book browse” through the sample order of service and/or zoom in on certain content.

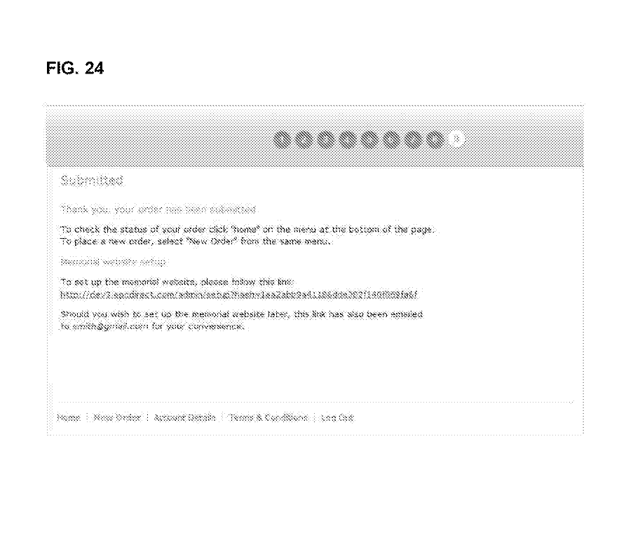

FIG. 24 is a pictorial diagram illustrating a portion of the display of a web client having an order confirmation page presented to users through the bereavement package ordering platform, according to certain embodiments. As shown in FIG. 24, in certain embodiments, after confirming the accuracy of the samples and submitting the order, the web client may display a confirmation page. The page may include a confirmation number, and other information, such as link to view, edit or complete certain products or services (e.g., a memorial website), and/or a link to view the status of the order.

It is understood that the various systems and methods described in connection with the foregoing figures are exemplary, and any other suitable systems or methods may be used. The foregoing is merely illustrative of the principles of this invention and various modifications can be made by those skilled in the art without departing from the scope and spirit of the invention. As an example, although certain embodiments of the bereavement package ordering platform have been described in connection with certain types of bereavement products and services, such as order of service cards, attendance cards, and memorial websites, the platform may provide any number, manner and type of bereavement products and services associated with any one or more features, functionalities or content. One skilled in the art will appreciate that the present invention can be practiced in other than the described embodiments, which are presented for purposes of illustration and not limitation, and the present invention is limited only by the claims which follow.

What is claimed is:

1. A system for allowing users to obtain personalized bereavement packages, the system comprising:
a plurality of client devices associated with one or more memorial service providers, the client devices comprising input devices for receiving memorial service data and package selections from a set of users associated with the memorial service providers and being configured to transmit the memorial service data and package selections over a network to enable the creation and delivery of personalized bereavement packages to individuals organizing a memorial service;
a server device having a processor and physical memory, the physical memory storing instructions that cause the processor to:
provide a bereavement package ordering platform adapted to assist the users with the selection, personalization and ordering of bereavement products and services, wherein the bereavement package ordering platform includes a graphical wizard that presents a plurality of customizable templates that permit the users to digitally design and personalize a plurality of print-based bereavement products;
receive, over the network from a client device associated with a user included in the set of users, a request to create a personalized bereavement package through the bereavement package ordering platform;
present, on the client device, a plurality of bereavement products and services including at least one bereavement product or service that is associated with a machine readable element;
receive, over the network from the client device, a plurality of package selections pertaining to the presented bereavement products and services, wherein at least a portion of the package selections are applied to the customizable templates to personalize layouts and content for the print-based bereavement products that are presented to the user by the graphical wizard;
generate bereavement package data based on the plurality of package selections received from the client device, the bereavement package data including:
product selection data pertaining to a plurality of bereavement products and services selected by the user, the selected bereavement products and services including the plurality of print-based bereavement products;
product personalization data representing user-defined content for inclusion with one or more of the print-based bereavement products, wherein the product personalization data includes data pertaining to a personalized machine readable element associated with at least one of the selected bereavement products and services; and
a personalized memorial website that is generated by the server in response to selections made by the user, wherein the personalized memorial website is accessible via embedded information that that is incorporated in the machine readable element which identifies a location of a memorial presentation and provides access to a memorial presentation; and
wherein the bereavement package data is utilized to place an order with a printing vendor to produce the plurality of print-based bereavement products for delivery to the user associated with the client device or an individual organizing the memorial service; and
receive a second request from the printing vendor to access an admin client associated with the bereavement package ordering platform, wherein the admin client assists the printing vendor with tracking a plurality of orders for bereavement packages; and
a plurality of print centers associated with one or more printing vendors, the print centers comprising printing devices for creating print-based bereavement products and a second set of client devices for receiving bereavement package data over the network from the server device and enabling the printing vendors to access the admin client associated with the bereavement package ordering platform, wherein the print centers are configured to:
receive, at the second set of client devices over the network from the server device, the bereavement package data generated by the server device;
produce, using the printing devices, the plurality of print-based bereavement products selected by the user; and
deliver the plurality of produced print-based bereavement products to the user or the individual organizing the memorial service.

2. The system of claim 1, wherein the machine readable element is a QR code.

3. The system of claim 1, wherein the at least one bereavement product or service that is associated with the machine readable element is a print-based bereavement product and the machine readable element is printed on the print-based bereavement product.

4. The system of claim 1, wherein the at least one bereavement product or service that is associated with the machine readable element is an electronic bereavement product or service and the machine readable element is displayed in conjunction with the electronic bereavement product or service.

5. The system of claim 1, wherein the machine readable element is associated with a function that is executable in response to scanning or reading the machine readable element with a reading device.

6. The system of claim 5, wherein the reading device is a mobile phone that includes an application for reading the machine readable element.

7. The system of claim 5, wherein the function that is executed in response to scanning or reading the machine readable element includes a function that automatically executes a web browser application on the reading device and loads a web address using information that is stored in the machine readable element.

8. The system of claim 7, wherein the web address identifies content of the memorial presentation and the memorial presentation comprises a video, slideshow or audio recording.

9. The system of claim 7, wherein the web address identifies a personalized memorial website that includes the memorial presentation or that permits a memorial presentation to be downloaded.

10. The system of claim 5, wherein the function that is executed in response to scanning or reading the machine readable element includes a function that automatically sends a text message to the reading device.

11. The system of claim 5, wherein the function that is executed in response to scanning or reading the machine readable element includes a function that automatically sends an e-mail to an individual associated with the reading device.

12. The system of claim 1, wherein one or more of the customizable templates used to design the print-based bereavement products are targeted to the user based on one or more of: a geographic location, an occupation or a religious theme.
